(19) United States
(12) Patent Application Publication
(10) Pub. No.: US 2017/0187261 A1
(43) Pub. Date: Jun. 29, 2017

(54) VIBRATION MOTOR, VIBRATOR-ATTACHED BOARD, SILENT NOTIFICATION DEVICE, AND METHOD FOR MANUFACTURING VIBRATION MOTOR

(71) Applicant: Nidec Seimitsu Corporation, Ueda-shi (JP)

(72) Inventor: Daisuke TAKAGI, Ueda-shi (JP)

(21) Appl. No.: 15/386,167

(22) Filed: Dec. 21, 2016

(30) Foreign Application Priority Data
Dec. 25, 2015 (JP) 2015-253244

(51) Int. Cl. H02K 7/06; G08B 6/00; H02K 15/02; H02K 7/08; B06B 1/04

(52) U.S. Cl. CPC H02K 7/063; H02K 7/083; B06B 1/045; H02K 15/02; G08B 6/00

(57) ABSTRACT

A vibration motor includes a base portion arranged to extend perpendicularly to a central axis extending in a vertical direction; a shaft having a lower end fixed to the base portion, and arranged to project upward along the central axis; a circuit board; a coil portion; a bearing portion; a rotor holder; a magnet portion; an eccentric weight; a cover portion; and a motor electrode portion electrically connected to the circuit board, and arranged to project downward below a lower surface of the base portion. The entire base portion and the entire circuit board are arranged inside of an outer circumferential edge of a lower end of the cover portion.

### CROSS REFERENCE TO RELATED APPLICATIONS

This application claims the benefit of priority to Japanese Patent Application No. 2015-253244 filed on Dec. 25, 2015. The entire contents of this application are hereby incorporated herein by reference.

### BACKGROUND OF THE INVENTION

### 1. Field of the Invention

The present invention relates to a vibration motor, a vibrator-attached board, a silent notification device, and a method for manufacturing the vibration motor.

### 2. Description of the Related Art

Brushless vibration motors in the shape of a thin coin are typically used in silent notification devices in mobile communication apparatuses or the like, or for other purposes. In a vibration motor described in JP-A 2011-234532, an opening of a tubular portion 22 of a cover case 20 is closed by a base plate 12.

In the vibration motor described in JP-A 2011-234532, a portion of the base plate 12 projects radially outwardly of the tubular portion 22 of the cover case 20. Therefore, the radial dimension of the vibration motor can be reduced only to a limited degree.

### SUMMARY OF THE INVENTION

A vibration motor according to a preferred embodiment of the present invention includes a base portion arranged to extend perpendicularly to a central axis extending in a vertical direction; a shaft having a lower end fixed to the base portion, and arranged to project upward along the central axis; a circuit board arranged above the base portion; a coil portion attached to the circuit board, and arranged radially opposite to the shaft with a gap therebetween; a bearing portion attached to the shaft to be rotatable with respect to the shaft above the coil portion; a rotor holder attached to the bearing portion; a magnet portion attached to the rotor holder; an eccentric weight attached to the rotor holder; a cover portion arranged to cover, at least in part, upper and lateral sides of the rotor holder and the eccentric weight, and fixed to an upper end of the shaft and an outer edge portion of the base portion; and a motor electrode portion electrically connected to the circuit board, and arranged to project downward below a lower surface of the base portion. The entire base portion and the entire circuit board are arranged inside of an outer circumferential edge of a lower end of the cover portion.

The vibration motor according to the above preferred embodiment of the present invention is able to achieve a reduction in radial dimension.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a vibration motor according to a first preferred embodiment of the present invention.

FIG. 2 is a vertical sectional view of the vibration motor.

FIG. 3 is a perspective view of a rotating portion and a stationary portion of the vibration motor.

FIG. 4 is a perspective view of the stationary portion.

FIG. 5 is a perspective view of the stationary portion as viewed from below.

FIG. 6 is a plan view of a base portion of the vibration motor.

FIG. 7 is a flowchart illustrating a procedure for manufacturing the vibration motor.

FIG. 8 is a perspective view of an initial electrode workpiece according to the first preferred embodiment of the present invention.

FIG. 9 is a sectional view of a vibrator-attached board according to a preferred embodiment of the present invention.

FIG. 10 is a plan view illustrating a board electrode portion according to a preferred embodiment of the present invention.

FIG. 11 is a perspective view of a rotating portion and a stationary portion of a vibration motor according to a second preferred embodiment of the present invention.

FIG. 12 is a flowchart illustrating a procedure for manufacturing the vibration motor according to the second preferred embodiment of the present invention.

FIG. 13 is a perspective view of an initial electrode workpiece according to the second preferred embodiment of the present invention.

FIG. 14 is a perspective view of a stationary portion of a vibration motor according to a third preferred embodiment of the present invention.

### DETAILED DESCRIPTION OF THE PREFERRED EMBODIMENTS

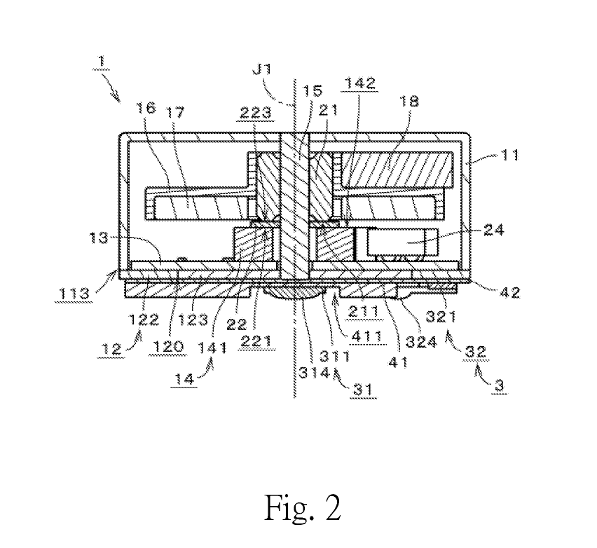

It is assumed herein that a vertical direction is defined as a direction in which a central axis J1 of a vibration motor 1 extends, and that an upper side and a lower side along the central axis J1 in FIG. 2 are referred to simply as an upper side and a lower side, respectively. It should be noted, however, that the above definitions of the vertical direction and the upper and lower sides are not meant to indicate relative positions or directions of different members or portions when those members or portions are actually installed in a device. It is also assumed herein that an axial direction, i.e., a direction parallel to the central axis J1, is referred to as the vertical direction. Further, it is assumed herein that radial directions centered on the central axis J1 are simply referred to by the term “radial direction”, “radial”, or “radially”, and that a circumferential direction about the central axis J1 is simply referred to by the term “circumferential direction”, “circumferential”, or “circumferentially”.

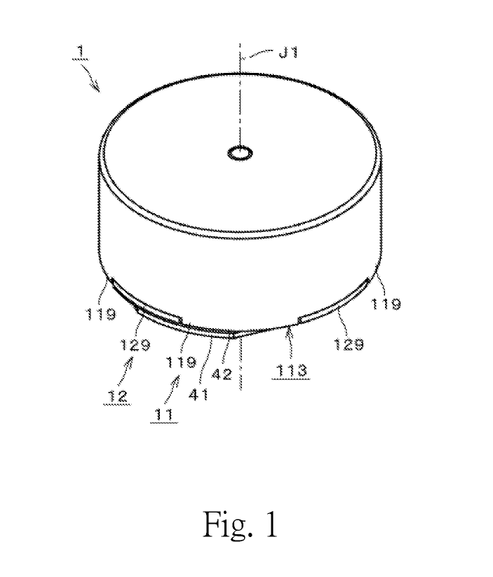

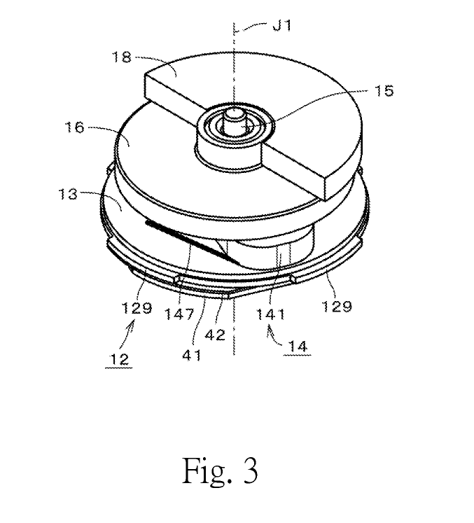

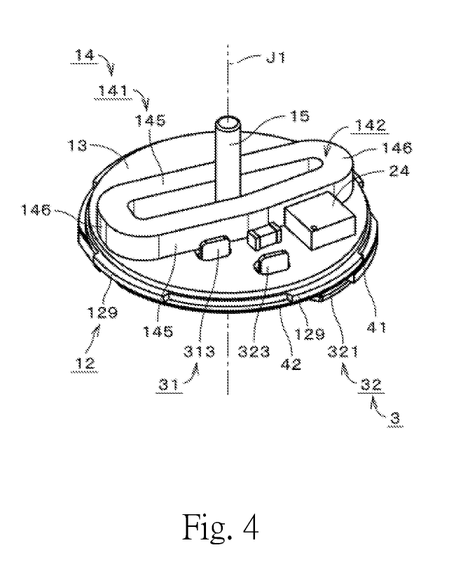

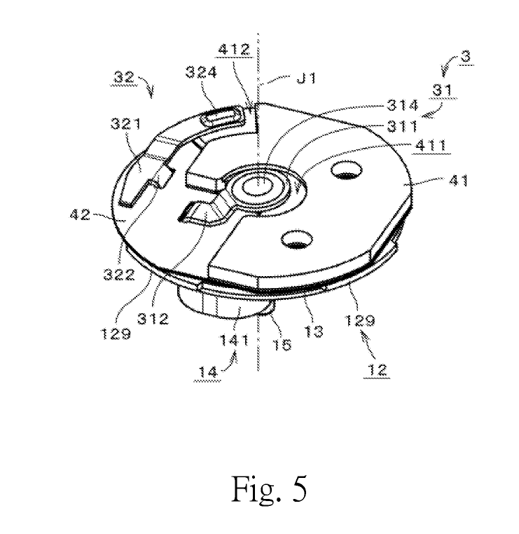

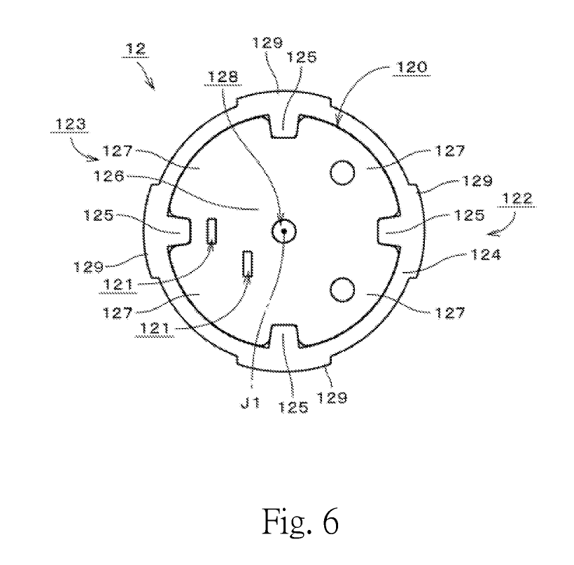

FIG. 1 is a perspective view illustrating the external appearance of the vibration motor 1 according to a first preferred embodiment of the present invention. FIG. 2 is a vertical sectional view of the vibration motor 1. Parallel oblique lines are omitted for sections of details in FIG. 2. In addition, in FIG. 2, features on the far side of the section of the vibration motor 1 are also depicted. FIG. 3 is a perspective view of a rotating portion and a stationary portion of the vibration motor 1. FIG. 4 is a perspective view of the stationary portion of the vibration motor 1 as viewed from above. FIG. 5 is a perspective view of the stationary portion of the vibration motor 1 as viewed from below. FIG. 6 is a plan view of a base portion 12.

The vibration motor 1 is a brushless motor in the shape of a coin. The vibration motor 1 is used in, for example, a silent notification device in a mobile communication apparatus, such as a cellular phone. In other words, the vibration motor 1 is included in the silent notification device, for example.

The vibration motor 1 includes a cover portion 11 and the base portion 12. The cover portion 11 is substantially cylindrical. More specifically, the cover portion 11 is substantially in the shape of a covered cylinder, and is centered on the central axis J1. An outer circumferential edge 113 of a cover portion lower end, which is a lower end of the cover portion 11, is substantially circular. The base portion 12 is substantially in the shape of a disk. The base portion 12 is arranged to extend perpendicularly to the central axis J1, which extends in the vertical direction. A lower end portion of the cover portion 11 is fixed to an outer edge portion of the base portion 12. The base portion 12 is arranged to close a lower opening of the cover portion 11. The entire base portion 12 is arranged radially inside of the outer circumferential edge 113 of the cover portion lower end. The cover portion 11 is made of a metal. The base portion 12 is also made of a metal. The cover portion 11 and the base portion 12 are joined to each other through, for example, welding. The diameter of the cover portion 11 is, for example, in the range of 4 mm to 15 mm both inclusive. The vertical height of the cover portion 11 is, for example, in the range of 1.5 mm to 5.0 mm both inclusive. The thickness of the base portion 12 is, for example, 0.8 mm or less.

The vibration motor 1 further includes a motor electrode portion 3. The motor electrode portion 3 is arranged to project below a lower surface of the base portion 12. The motor electrode portion 3 includes a first motor electrode portion 31 and a second motor electrode portion 32. Each of the first and second motor electrode portions 31 and 32 is arranged radially inside of the outer circumferential edge 113 of the cover portion lower end. The first motor electrode portion 31 is arranged on the central axis J1. The first motor electrode portion 31 is substantially circular and is centered on the central axis J1 in a plan view. The second motor electrode portion 32 is arranged around the first motor electrode portion 31 with a radial gap between the first and second motor electrode portions 31 and 32. The second motor electrode portion 32 is substantially in the shape of an arc in a plan view.

The vibration motor 1 further includes a lower sheet 41. The lower sheet 41 is a sheet-shaped member that is elastically deformable. The lower sheet 41 is made of, for example, silicone rubber. Note that the lower sheet 41 may alternatively be made of any other desirable insulating material. The lower sheet 41 is attached to the lower surface of the base portion 12 around the motor electrode portion 3. The entire lower sheet 41 is arranged radially inside of the outer circumferential edge 113 of the cover portion lower end. The lower sheet 41 is, for example, substantially in a fan shape and is centered on the central axis J1 in a plan view. The radius of the lower sheet 41 is substantially equal to the radius of the base portion 12. In the preferred embodiment illustrated in FIG. 5, the lower sheet 41 has an area about two thirds of the area of the base portion 12. A portion of the lower sheet 41 is arranged between the motor electrode portion 3 and the base portion 12. Another portion of the lower sheet 41 is arranged around the motor electrode portion 3.

The vibration motor 1 further includes an insulation sheet 42. The insulation sheet 42 is a sheet-shaped member made of an insulating material. The insulation sheet 42 is arranged between the base portion 12 and the lower sheet 41, and is attached to the lower surface of the base portion 12. The lower sheet 41 is arranged below the insulation sheet 42, and is attached to a lower surface of the insulation sheet 42. In other words, the lower sheet 41 is indirectly attached to the base portion 12 with the insulation sheet 42 therebetween. The lower sheet 41 is fixed to the insulation sheet 42 through, for example, an adhesive layer. The insulation sheet 42 is fixed to the base portion 12 through, for example, an adhesive layer. Note that the concept of “adhesive layer” includes an adhesive, a double-sided tape, glue, and the like in the present preferred embodiment and in other preferred embodiments of the present invention described below.

The entire insulation sheet 42 is arranged radially inside of the outer circumferential edge 113 of the cover portion lower end. The insulation sheet 42 is substantially in the shape of a disk and is centered on the central axis J1. The insulation sheet 42 has substantially the same size as that of the base portion 12 in a plan view. The insulation sheet 42 is arranged to cover substantially the entire lower surface of the base portion 12. The insulation sheet 42 has an area greater than that of the lower sheet 41 in a plan view. Therefore, a portion of the insulation sheet 42 does not overlap with the lower sheet 41 when viewed in the vertical direction. In other words, a portion of the lower surface of the insulation sheet 42 is not covered with the lower sheet 41.

The first motor electrode portion 31 includes a disk-shaped portion 311, a first laterally projecting portion 312, and a first upwardly projecting portion 313. The disk-shaped portion 311, the first laterally projecting portion 312, and the first upwardly projecting portion 313 are defined by a single continuous monolithic member. The disk-shaped portion 311 is substantially in the shape of a disk and is centered on the central axis J1. The first laterally projecting portion 312 is arranged to project radially outward from an outer edge portion of the disk-shaped portion 311 substantially horizontally. The first upwardly projecting portion 313 is arranged to project upward from a radially outer end portion of the first laterally projecting portion 312. A first board connection portion 314 is provided on a lower surface of a central portion of the disk-shaped portion 311. The first board connection portion 314 is arranged to project downward from a lower surface of the disk-shaped portion 311.

The disk-shaped portion 311 is arranged below the lower sheet 41, and is arranged to be in contact with a lower surface of the lower sheet 41. That is, the first board connection portion 314 is arranged below the lower sheet 41 to overlap with the lower sheet 41 when viewed in the vertical direction. A portion of the lower sheet 41 which makes contact with the disk-shaped portion 311 and a portion of the lower sheet 41 which is around the disk-shaped portion 311 together define a sheet recessed portion 411 of the lower sheet 41, which is recessed upward relative to another portion of the lower sheet 41. In other words, a lower surface of the sheet recessed portion 411 of the lower sheet 41, which is arranged between the disk-shaped portion 311 and the base portion 12, is arranged at a level higher than that of a lower surface of a portion of the lower sheet 41 which is around the sheet recessed portion 411. A lower end portion of the first board connection portion 314 is arranged, for example, at a vertical level substantially the same as or lower than that of the lower surface of the portion of the lower sheet 41 which is around the sheet recessed portion 411.

Each of the first laterally projecting portion 312 and the first upwardly projecting portion 313 is arranged at a position that does not overlap with the lower sheet 41 when viewed in the vertical direction. The first laterally projecting portion 312 is arranged to be in contact with the portion of the lower surface of the insulation sheet 42 which is not covered with the lower sheet 41. The first upwardly projecting portion 313 is arranged to pass through the insulation sheet 42, the base portion 12, and a circuit board 13, which will be described below, to project above the circuit board 13.

The second motor electrode portion 32 includes an arc-shaped portion 321, a second laterally projecting portion 322, and a second upwardly projecting portion 323. The arc-shaped portion 321, the second laterally projecting portion 322, and the second upwardly projecting portion 323 are defined by a single continuous monolithic member. The arc-shaped portion 321 is defined by a portion of a substantially annular plate centered on the central axis J1. The second laterally projecting portion 322 is arranged to project radially inward from a radially inner edge portion of the arc-shaped portion 321. The second upwardly projecting portion 323 is arranged to project upward from a radially inner end portion of the second laterally projecting portion 322. A second board connection portion 324 is provided on a lower surface of one circumferential end portion of the arc-shaped portion 321. The second board connection portion 324 is arranged to project downward from a lower surface of the arc-shaped portion 321. The end portion of the arc-shaped portion 321 on which the second board connection portion 324 is provided is arranged below the lower sheet 41, and is arranged to be in contact with the lower surface of the lower sheet 41. That is, the second board connection portion 324 is arranged below the lower sheet 41 to overlap with the lower sheet 41 when viewed in the vertical direction.

A portion of the lower sheet 41 which makes contact with the end portion of the arc-shaped portion 321 on which the second board connection portion 324 is provided and an adjacent portion thereof together define a sheet recessed portion 412 of the lower sheet 41, which is recessed upward relative to another portion of the lower sheet 41. In other words, a lower surface of the sheet recessed portion 412 of the lower sheet 41, which is arranged between the aforementioned end portion of the arc-shaped portion 321 and the base portion 12, is arranged at a level higher than that of a lower surface of a portion of the lower sheet 41 which is around the sheet recessed portion 412. A lower end portion of the second board connection portion 324 is arranged, for example, at a vertical level substantially the same as or lower than that of the lower surface of the portion of the lower sheet 41 which is around the sheet recessed portion 412.

A remaining portion of the arc-shaped portion 321 excluding the end portion thereof on which the second board connection portion 324 is provided is arranged at a position that does not overlap with the lower sheet 41 when viewed in the vertical direction, and is arranged to be in contact with the portion of the lower surface of the insulation sheet 42 which is not covered with the lower sheet 41. In other words, this remaining portion of the arc-shaped portion 321 of the second motor electrode portion 32 is arranged on the lateral side of the lower sheet 41 below the base portion 12, and is arranged radially opposite to the lower sheet 41.

Each of the second laterally projecting portion 322 and the second upwardly projecting portion 323 is arranged at a position circumferentially away from the second board connection portion 324. Each of the second laterally projecting portion 322 and the second upwardly projecting portion 323 is arranged at a position that does not overlap with the lower sheet 41 when viewed in the vertical direction. The second upwardly projecting portion 323 is arranged to pass through the insulation sheet 42, the base portion 12, and the circuit board 13 to project above the circuit board 13.

The vibration motor 1 further includes the circuit board 13, a coil portion 14, a shaft 15, a rotor holder 16, a magnet portion 17, and an eccentric weight 18. The vibration motor 1 further includes a bearing portion 21 and a spacer 22. Each of the base portion 12, the circuit board 13, the coil portion 14, the shaft 15, and the spacer 22 is included in the stationary portion. Each of the bearing portion 21, the rotor holder 16, the magnet portion 17, and the eccentric weight 18 is included in the rotating portion. FIG. 3 illustrates the vibration motor 1 with the cover portion 11 removed therefrom. Each of FIGS. 4 and 5 illustrates the vibration motor 1 with the cover portion 11 and the rotating portion removed therefrom.

The base portion 12 includes, for example, a base nonmagnetic portion 122 and a base magnetic portion 123. The base nonmagnetic portion 122 is made of a nonmagnetic metal. The base nonmagnetic portion 122 is made of, for example, an austenitic stainless steel. The base magnetic portion 123 is made of a magnetic metal. The base magnetic portion 123 is made of, for example, iron.

As illustrated in FIG. 6, the base nonmagnetic portion 122 is substantially in the shape of an annular plate. The base magnetic portion 123 is arranged radially inside of the base nonmagnetic portion 122. The base magnetic portion 123 is fixed to an edge portion of the base nonmagnetic portion 122. The base magnetic portion 123 is arranged to extend from the edge portion of the base nonmagnetic portion 122 substantially perpendicularly to the vertical direction.

The base nonmagnetic portion 122 includes a nonmagnetic outer circumferential portion 124 and a plurality of nonmagnetic element portions 125. In the preferred embodiment illustrated in FIG. 6, the base nonmagnetic portion 122 includes four nonmagnetic element portions 125. The nonmagnetic outer circumferential portion 124 is substantially annular. In more detail, the nonmagnetic outer circumferential portion 124 is substantially in the shape of a circular ring, and is centered on the central axis J1. The nonmagnetic outer circumferential portion 124 is arranged to surround an outer periphery of the base magnetic portion 123.

Each of the nonmagnetic element portions 125 is defined integrally with the nonmagnetic outer circumferential portion 124. Each of the nonmagnetic element portions 125 is arranged to project radially inward from the nonmagnetic outer circumferential portion 124. Each nonmagnetic element portion 125 is a nonmagnetic projecting portion arranged to project from an inner circumferential edge of the nonmagnetic outer circumferential portion 124 substantially perpendicularly to the vertical direction toward the central axis J1. Each of the nonmagnetic element portions 125 is arranged to have the same shape. The circumferential width of each of the nonmagnetic element portions 125 is arranged to decrease in a radially inward direction.

The nonmagnetic element portions 125 are arranged in the circumferential direction, and are arranged at positions opposed to the magnet portion 17 in the vertical direction. The nonmagnetic element portions 125 are arranged at equal angular intervals in the circumferential direction. In the preferred embodiment illustrated in FIG. 6, the four nonmagnetic element portions 125 are arranged at intervals of 90 degrees. In other words, in a plan view, an angle defined between a straight line that joins a circumferential middle of each nonmagnetic element portion 125 and the central axis J1, and a straight line that joins the circumferential middle of the nonmagnetic element portion 125 adjacent thereto and the central axis J1 is 90 degrees.

The base magnetic portion 123 includes a magnetic central portion 126 and a plurality of magnetic element portions 127. In the preferred embodiment illustrated in FIG. 6, the base magnetic portion 123 includes four magnetic element portions 127. The magnetic central portion 126 is substantially in the shape of a disk, and is centered on the central axis J1. A base central through hole 128, which passes through the base portion 12 in the vertical direction, is defined in a central portion of the magnetic central portion 126. The base central through hole 128 is, for example, circular in a plan view. The magnetic central portion 126 includes two electrode holes 121 through which the first upwardly projecting portion 313 of the first motor electrode portion 31 and the second upwardly projecting portion 323 of the second motor electrode portion 32, respectively, are inserted. Each of the two electrode holes 121 is a through hole passing through the base portion 12 in the vertical direction. Each electrode hole 121 is, for example, substantially rectangular in a plan view.

Each of the magnetic element portions 127 is defined integrally with the magnetic central portion 126. Each of the magnetic element portions 127 is arranged to project radially outward from the magnetic central portion 126. Each magnetic element portion 127 is a magnetic projecting portion arranged to project from an outer circumferential edge of the magnetic central portion 126 substantially perpendicularly to the vertical direction. Each of the magnetic element portions 127 is arranged to have the same shape. The magnetic element portions 127 are arranged to extend from the magnetic central portion 126 in a radial manner with the central axis J1 as a center. The circumferential width of each of the magnetic element portions 127 is arranged to increase in a radially outward direction.

The magnetic element portions 127 are arranged in the circumferential direction, and are arranged at positions opposed to the magnet portion 17 in the vertical direction. The magnetic element portions 127 are arranged at equal angular intervals in the circumferential direction. In the preferred embodiment illustrated in FIG. 6, the four magnetic element portions 127 are arranged at intervals of 90 degrees. In other words, in a plan view, an angle defined between a straight line that joins a circumferential middle of each magnetic element portion 127 and the central axis J1, and a straight line that joins the circumferential middle of the magnetic element portion 127 adjacent thereto and the central axis J1 is 90 degrees.

The magnetic element portions 127 are arranged to alternate with the nonmagnetic element portions 125 in the circumferential direction. The circumferential width of each nonmagnetic element portion 125 is smaller than the circumferential width of each magnetic element portion 127 at any radial position. The nonmagnetic element portions 125 and the magnetic element portions 127 are arranged at equal angular intervals in the circumferential direction. In the preferred embodiment illustrated in FIG. 6, the four nonmagnetic element portions 125 and the four magnetic element portions 127 are arranged at intervals of 45 degrees. In other words, in a plan view, an angle defined between the straight line that joins the circumferential middle of each nonmagnetic element portion 125 and the central axis J1, and the straight line that joins the circumferential middle of the magnetic element portion 127 adjacent to the nonmagnetic element portion 125 and the central axis J1 is 45 degrees.

The base nonmagnetic portion 122 and the base magnetic portion 123 are welded to each other at a boundary portion 120 between the base nonmagnetic portion 122 and the base magnetic portion 123, and are thus fixed to each other. The base nonmagnetic portion 122 and the base magnetic portion 123 are welded to each other at, for example, a plurality of separate positions along the boundary portion 120. Note that the base nonmagnetic portion 122 and the base magnetic portion 123 may alternatively be welded to each other at the boundary portion 120 substantially over the entire length thereof. Also note that the base nonmagnetic portion 122 and the base magnetic portion 123 may not necessarily be fixed to each other through welding, but may alternatively be fixed to each other through, for example, adhesion or press fitting.

The base nonmagnetic portion 122 and the base magnetic portion 123 are arranged not to overlap with each other at any position outside of the boundary portion 120 when viewed in the vertical direction. In other words, no portion of the base nonmagnetic portion 122 is arranged over or under the base magnetic portion 123 at any position outside of the boundary portion 120.

Note that a portion of the base portion 12 which corresponds to the above-described base nonmagnetic portion 122, and a portion of the base portion 12 which corresponds to the above-described base magnetic portion 123 may alternatively be made of a magnetic metal and a nonmagnetic metal, respectively, for example. Also note that the entire base portion 12 may alternatively be made of a magnetic metal, for example. Also note that the base portion 12 may alternatively be made of any desirable material other than metals. Also note that the cover portion 11 may alternatively be made of any desirable material other than metals.

The circuit board 13 is arranged on the base portion 12. A central portion of the circuit board 13 includes a board central through hole through which the shaft 15 is inserted. The board central through hole is, for example, circular in a plan view. The circuit board 13 is arranged to cover substantially an entire upper surface of the base portion 12 except an outer edge portion of the upper surface of the base portion 12. Therefore, the entire circuit board 13 is arranged radially inside of the outer circumferential edge 113 of the cover portion lower end. The circuit board 13 is fixed to the base portion 12 through an adhesive layer, for example. The circuit board 13 is a flexible printed circuit (FPC) board, which has flexibility.

An electronic component 24 is attached onto the circuit board 13. The electronic component 24 is electrically connected to the circuit board 13. The electronic component 24 is arranged to detect rotation of the magnet portion 17, for example. The electronic component 24 is, for example, a Hall sensor. Note that the electronic component 24 may alternatively be a capacitor, a resistor, or any of various other components.

The above-described motor electrode portion 3 is electrically connected to the circuit board 13. More specifically, each of a portion of the first upwardly projecting portion 313 of the first motor electrode portion 31 which projects above the circuit board 13, and a portion of the second upwardly projecting portion 323 of the second motor electrode portion 32 which projects above the circuit board 13 is electrically connected to an upper surface of the circuit board 13 through, for example, a solder, in an interior space of the vibration motor 1. The interior space of the vibration motor 1 is a space enclosed by the cover portion 11 and the base portion 12.

The coil portion 14 is attached onto the circuit board 13. The coil portion 14 is electrically connected to the circuit board 13. In the preferred embodiment illustrated in FIGS. 2 to 5, the coil portion 14 is defined by a single annular coil 141. The shaft 15 is arranged inside of the coil 141. The coil 141 is fixed onto the circuit board 13 through an adhesive layer, for example.

The coil 141 is, for example, substantially in the shape of a rectangular ring, elongated in one radial direction in a plan view. The coil 141 includes two long side portions 145 and two short side portions 146. Each of the two long side portions 145 is arranged to extend in a longitudinal direction of the coil 141 with the shaft 15 arranged between the two long side portions 145. The two short side portions 146 are arranged to join both end portions of the two long side portions 145. Each of the two short side portions 146, which is a radially outer end portion of the coil 141, is arranged above the nonmagnetic outer circumferential portion 124 of the base portion 12, and is arranged to overlap with the nonmagnetic outer circumferential portion 124 when viewed in the vertical direction. In addition, the radially outer end portion of the coil 141 is arranged radially outward of an outer circumferential edge of the magnet portion 17. Note that the radially outer end portion of the coil 141 may alternatively be arranged radially inward of the outer circumferential edge of the magnet portion 17.

Lead wires 147 extending from the coil 141 are connected to the circuit board 13 on the opposite side of the coil 141 with respect to the electronic component 24. Each lead wire 147 is connected to the circuit board 13 through, for example, soldering. Note that the lead wire 147 may alternatively be connected to the circuit board 13 by a method other than soldering. Also note that the position at which the lead wire 147 is connected to the circuit board 13 may not necessarily be on the opposite side of the coil 141 with respect to the electronic component 24, but may alternatively be at any other appropriate position.

The shaft 15 is arranged to have the central axis J1 as a center thereof. A lower end of the shaft 15 is fixed to the base portion 12. More specifically, the lower end of the shaft 15 is fixed in the base central through hole 128. For example, the lower end of the shaft 15 is press fitted in the base central through hole 128, and is welded to the base portion 12. A lower end surface of the shaft 15 is arranged at substantially the same vertical level as that of a portion of the lower surface of the base portion 12 which is around the base central through hole 128.

The shaft 15 is arranged to project upward from the base portion 12 along the central axis J1. An upper end of the shaft 15 is fixed to a central portion of a top cover portion of the cover portion 11. The shaft 15 is fixed to the cover portion 11 through, for example, welding and press fitting. The shaft 15 is arranged radially opposite to the coil 141 with a gap therebetween. In other words, the coil portion 14 is arranged radially opposite to the shaft 15 with the gap therebetween. No member of the vibration motor 1 is arranged in this gap. The shaft 15 is made of, for example, a metal. Note that the shaft 15 may alternatively be made of another material.

The spacer 22 is a substantially annular plate-shaped member including a through hole defined in a center thereof. The spacer 22 is, for example, in the shape of a circular ring, and is centered on the central axis J1. Note that the spacer 22 may alternatively be, for example, in the shape of the letter “C”, that is, a circular ring with one circumferential portion omitted. The shaft 15 is inserted through the through hole of the spacer 22. The spacer 22 is attached to the shaft 15 through, for example, press fitting. The spacer 22 is arranged above the coil portion 14, and is fixed to the shaft 15. The spacer 22 is made of, for example, a resin. Note that the spacer 22 may alternatively be made of another material. Also note that the spacer 22 may alternatively be attached to the shaft 15 by a method other than press fitting.

A lower surface 221 of the spacer 22 is arranged opposite to an upper surface 142 of the coil 141 of the coil portion 14 in the vertical direction. In the preferred embodiment illustrated in FIG. 2, the lower surface 221 of the spacer 22 is arranged to be in contact with the upper surface 142 of the coil 141 of the coil portion 14.

The bearing portion 21 is an annular member including a through hole defined in a center thereof. In the preferred embodiment illustrated in FIG. 2, the bearing portion 21 is substantially cylindrical, and is centered on the central axis J1. The shaft 15 is inserted through the through hole of the bearing portion 21. The bearing portion 21 is attached to the shaft 15 to be rotatable with respect to the shaft 15 above the coil 141 of the coil portion 14. In addition, the bearing portion 21 is arranged above the spacer 22. In other words, the spacer 22 is attached to the shaft 15 between the bearing portion 21 and the coil 141 of the coil portion 14.

As illustrated in FIG. 2, an upper surface 223 of the spacer 22 is arranged to be in contact with a lower surface 211 of the bearing portion 21. In the preferred embodiment illustrated in FIG. 2, the upper surface 223 of the spacer 22 is arranged to have an outside diameter greater than the outside diameter of the lower surface 211 of the bearing portion 21. The bearing portion is a plain bearing. Note that the bearing portion 21 may alternatively be a bearing of another type. The bearing portion 21 is made of, for example, a sintered metal. Preferably, the bearing portion 21 is impregnated with a lubricating oil. Note that the bearing portion 21 may alternatively be made of another material.

The rotor holder 16 is a member substantially in the shape of a covered cylinder. The rotor holder 16 is attached to the bearing portion 21. In more detail, an inner circumferential portion of a top cover portion of the rotor holder 16 is fixed to, for example, an outer circumferential portion of the bearing portion 21. The rotor holder 16 is thus supported by the bearing portion 21 to be rotatable with respect to the shaft 15. The rotor holder 16 is made of, for example, a metal.

The magnet portion 17 is a member substantially in the shape of a circular ring, and is centered on the central axis J1. The magnet portion 17 is attached to the rotor holder 16. In more detail, an upper surface of the magnet portion 17 is attached to a lower surface of the top cover portion of the rotor holder 16. The magnet portion 17 is arranged above the coil 141 of the coil portion 14, and is arranged opposite to the coil 141 in the vertical direction with a gap therebetween. The magnet portion 17 is arranged around the bearing portion 21. The bearing portion 21 is arranged radially inside of the magnet portion 17.

In the preferred embodiment illustrated in FIG. 2, the eccentric weight 18 is arranged to have a shape corresponding to that of a right half of a substantially cylindrical member. The eccentric weight 18 is substantially semicircular in a plan view. The eccentric weight 18 is attached to the rotor holder 16. In more detail, a lower surface of the eccentric weight 18 is attached to an upper surface of the top cover portion of the rotor holder 16 through, for example, an adhesive layer. The center of gravity of the eccentric weight 18 is radially away from the central axis J1.

The cover portion 11 is arranged to cover upper and lateral sides of the rotor holder 16 and the eccentric weight 18.

Note that the cover portion 11 may not necessarily cover the rotor holder 16 and the eccentric weight 18 in their entirety. The cover portion 11 may include an opening or the like defined therein, as long as the cover portion 11 is arranged to cover, at least in part, the upper and lateral sides of the rotor holder 16 and the eccentric weight 18. The cover portion 11 is fixed to the upper end of the shaft 15, and is also fixed to the outer edge portion of the base portion 12, as described above.

In the preferred embodiment illustrated in FIG. 1, the outer edge portion of the base portion 12 includes a plurality of base projecting portions 129 arranged at substantially equal angular intervals, each base projecting portion 129 slightly projecting radially outward. In addition, the lower end portion of the cover portion 11 includes a plurality of cover projecting portions 119 arranged at substantially equal angular intervals, each cover projecting portion 119 slightly projecting downward. When the cover portion 11 is fixed to the outer edge portion of the base portion 12, each base projecting portion 129 is arranged between two circumferentially adjacent ones of the cover projecting portions 119, and is arranged at the same vertical level as that of each cover projecting portion 119. In addition, each cover projecting portion 119 is arranged between two circumferentially adjacent ones of the base projecting portions 129, and is arranged at the same vertical level as that of each base projecting portion 129.

Each base projecting portion 129 is arranged to have a radial width substantially equal to the thickness of a lower end portion of a side wall portion of the cover portion 11. Each base projecting portion 129 is arranged to have a circumferential length substantially equal to the circumferential distance between the two circumferentially adjacent ones of the cover projecting portions 119. Each cover projecting portion 119 is arranged to have a vertical height substantially equal to the thickness of the outer edge portion of the base portion 12. Each cover projecting portion 119 is arranged to have a circumferential length substantially equal to the circumferential distance between the two circumferentially adjacent ones of the base projecting portions 129. An outer circumferential edge of each base projecting portion 129 is arranged to overlap with a portion of the outer circumferential edge 113 of the cover portion lower end which lies between the adjacent ones of the cover projecting portions 119 when viewed in the vertical direction. The outer circumferential edge of each base projecting portion 129 may alternatively be arranged radially inward of the portion of the outer circumferential edge 113 of the cover portion lower end which lies between the adjacent ones of the cover projecting portions 119.

In the vibration motor 1, an electric current is supplied to the coil 141 of the coil portion 14 through the circuit board 13 to generate a torque between the coil 141 and the magnet portion 17. The rotating portion, that is, a combination of the bearing portion 21, the rotor holder 16, the magnet portion 17, and the eccentric weight 18, is thus caused to rotate around the shaft 15. In the coil portion 14, a portion of the coil 141 which extends substantially in a radial direction is a torque generating portion that causes the torque to be generated between the magnet portion 17 and the coil 141. In the preferred embodiment illustrated in FIG. 4, each of the two long side portions 145 of the coil 141 is the torque generating portion. Since the center of gravity of the eccentric weight 18 is radially away from the central axis J1 as described above, the rotation of the eccentric weight 18 causes vibrations. If the supply of the electric current to the coil portion 14 is stopped, the rotation of the rotating portion stops. When the rotation of the rotating portion stops, a plurality of magnetic poles of the magnet portion 17 stop at predetermined circumferential stop positions.

The magnet portion 17 includes the plurality of magnetic poles. The number of magnetic poles is, for example, a multiple of two. Preferably, the number of magnetic poles is a multiple of four. The magnet portion 17 includes, for example, two north poles and two south poles. The two north poles and the two south poles are arranged to alternate with each other in the circumferential direction. The magnetic poles are arranged at equal angular intervals in the circumferential direction.

In the vibration motor 1, once the supply of the electric current to the coil 141 of the coil portion 14 is stopped, cogging torque generated between the magnetic element portions 127 of the base magnetic portion 123 and the magnet portion 17 causes the rotating portion to stop with each of the magnetic poles of the magnet portion 17 positioned over one of the magnetic element portions 127. In more detail, the rotating portion is caused to stop with the circumferential middle of each magnetic pole positioned opposite to the circumferential middle of one of the magnetic element portions 127 in the vertical direction.

This allows the circumferential middle of each magnetic pole of the magnet portion 17 to be displaced from each of the two long side portions 145, which are the torque generating portions of the coil 141, in the circumferential direction when the rotating portion is in a stopped state. In other words, each magnetic pole is prevented from being positioned at a dead point, which would prohibit the rotating portion from starting rotating, when the rotating portion is in the stopped state.

As described above, the vibration motor 1 includes the cover portion 11, the base portion 12, the circuit board 13, the coil portion 14, the shaft 15, the rotor holder 16, the magnet portion 17, the eccentric weight 18, and the bearing portion 21. The base portion 12 is arranged to extend perpendicularly to the central axis J1, which extends in the vertical direction. The lower end of the shaft 15 is fixed to the base portion 12. The shaft 15 is arranged to project upward along the central axis J1. The circuit board 13 is arranged on the base portion 12. The coil portion 14 is attached onto the circuit board 13, and is arranged radially opposite to the shaft 15 with a gap therebetween. The bearing portion 21 is attached to the shaft 15 to be rotatable with respect to the shaft 15 above the coil portion 14. The rotor holder 16 is attached to the bearing portion 21. The magnet portion 17 is attached to the rotor holder 16. The eccentric weight 18 is attached to the rotor holder 16. The cover portion 11 is arranged to cover, at least in part, the upper and lateral sides of the rotor holder 16 and the eccentric weight 18. The cover portion 11 is fixed to each of the upper end of the shaft 15 and the outer edge portion of the base portion 12.

The vibration motor 1 further includes the motor electrode portion 3. The motor electrode portion 3 is electrically connected to the circuit board 13. The motor electrode portion 3 is arranged to project below the lower surface of the base portion 12. The entire base portion 12 and the entire circuit board 13 are arranged inside of the outer circumferential edge 113 of the cover portion lower end. Thus, a portion projecting radially outward from the cover portion 11 can be eliminated. This contributes to reducing the radial dimension of the vibration motor 1.

In the vibration motor 1, the outer circumferential edge 113 of the cover portion lower end is circular as described above. In addition, the base portion 12 is substantially in the shape of a disk. The shape of the vibration motor 1 can thus be simplified. In addition, a reduction in the radial dimension of the vibration motor 1 can thus be achieved.

The vibration motor 1 further includes the lower sheet 41, which is in the shape of a sheet and is elastically deformable. The lower sheet 41 is attached to the lower surface of the base portion 12 around the motor electrode portion 3. Thus, when a lower surface of the vibration motor 1 is brought into contact with a target object, such as a board, to attach the vibration motor 1 to the target object, the lower sheet 41 is elastically deformed in accordance with the surface shape of the target object. This allows the motor electrode portion 3 to make stable contact with an electrode portion of the target object while minimizing tilting of the vibration motor 1 with respect to the target object. This in turn leads to accomplishing a stable electrical connection between the vibration motor 1 and the target object without use of a solder or the like.

As described above, a portion of the lower sheet 41 is arranged between the motor electrode portion 3 and the base portion 12. Thus, when the vibration motor 1 is attached to the target object, the portion of the lower sheet 41 which is arranged between the motor electrode portion 3 and the base portion 12 is elastically deformed to make the vertical level of a lower end portion of the motor electrode portion 3 approach the vertical level of the lower surface of the lower sheet 41. Thus, the lower surface of the lower sheet 41 easily makes contact with the target object around the motor electrode portion 3. As a result, the motor electrode portion 3 can be brought into more stable contact with the electrode portion of the target object.

The motor electrode portion 3 includes the first motor electrode portion 31 and the second motor electrode portion 32, which is substantially in the shape of an arc. The first and second motor electrode portions 31 and 32 are arranged to have the radial gap therebetween. This makes it possible to bring the motor electrode portion 3 into electrical connection with the electrode portion of the target object without the need for a precise consideration of the circumferential orientation of the vibration motor 1, when the vibration motor 1 is attached to the target object. As a result, the attachment of the vibration motor 1 to the target object is made easier.

As described above, in the vibration motor 1, the first motor electrode portion 31 is arranged on the central axis J1. In addition, the portion of the lower sheet 41 which is arranged between the first motor electrode portion 31 and the base portion 12 defines the sheet recessed portion 411, which is recessed upward relative to another portion of the lower sheet 41. This allows the vertical level of a lower end portion of the first motor electrode portion 31 arranged on the sheet recessed portion 411 to easily approach the vertical level of the lower surface of the portion of the lower sheet 41 which is around the sheet recessed portion 411. Thus, the lower surface of the lower sheet 41 easily makes contact with the target object around the first motor electrode portion 31. As a result, the first motor electrode portion 31 can be brought into stable contact with the electrode portion of the target object.

In addition, the second motor electrode portion 32 is arranged on the lateral side of the lower sheet 41 below the base portion 12, and is arranged radially opposite to the lower sheet 41. This contributes to preventing the second motor electrode portion 32 from significantly protruding downward below the lower sheet 41. This in turn contributes to reducing the vertical dimension of the vibration motor 1.

As described above, the vibration motor 1 further includes the insulation sheet 42 arranged between the base portion 12 and the lower sheet 41. This prevents a direct contact between the motor electrode portion 3 and the base portion 12. In addition, the insulation sheet 42 is fixed to the base portion 12 through the adhesive layer. Thus, the insulation sheet 42 can be easily fixed to the base portion 12. Further, a portion of the lower surface of the insulation sheet 42 is not covered with the lower sheet 41. This makes it possible to arrange a component, such as the motor electrode portion 3, on the lateral side of the lower sheet 41 below the base portion 12 without the component overlapping with the lower sheet 41 when viewed in the vertical direction. This contributes to reducing the vertical dimension of the vibration motor 1.

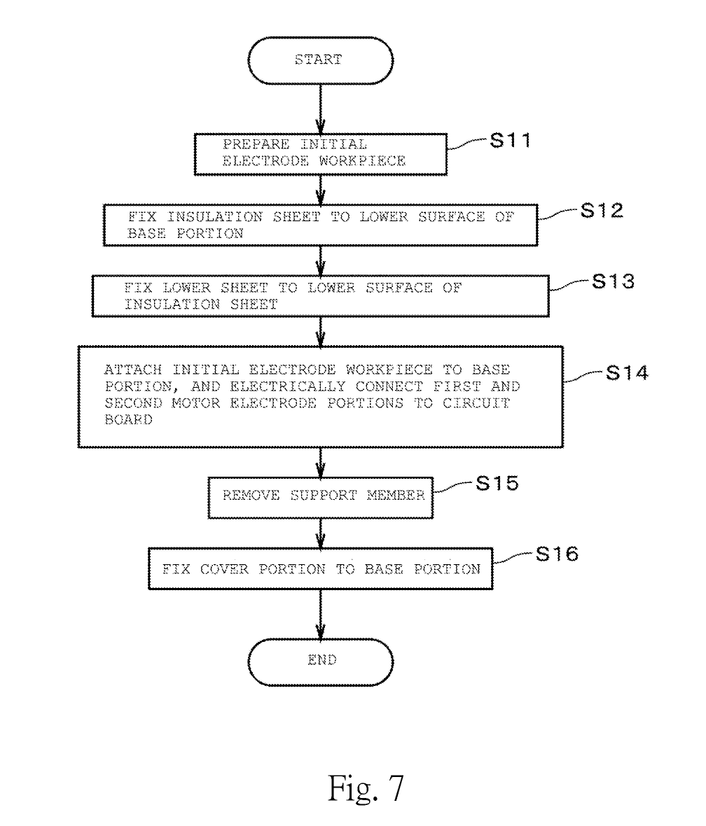

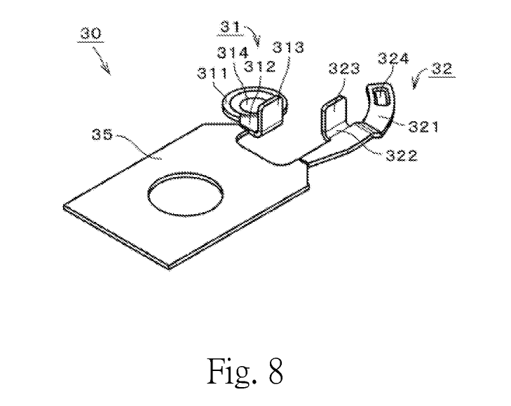

FIG. 7 is a flowchart illustrating an example procedure for manufacturing the vibration motor 1. At step S11, an initial electrode workpiece 30 as illustrated in FIG. 8 is prepared. The initial electrode workpiece 30 includes the first and second motor electrode portions 31 and 32 and a support member 35. The support member 35 is arranged to support the first and second motor electrode portions 31 and 32. The first and second motor electrode portions 31 and 32 and the support member 35 are defined by a single continuous monolithic member. In the preferred embodiment illustrated in FIG. 8, the support member 35 is connected to the first laterally projecting portion 312 of the first motor electrode portion 31 and the arc-shaped portion 321 of the second motor electrode portion 32. A groove portion, for example, is defined in each of a junction of the support member 35 and the first motor electrode portion 31 and a junction of the support member 35 and the second motor electrode portion 32. Therefore, the strength of each of these junctions is lower than the strength of other portions of the initial electrode workpiece 30.

Next, the insulation sheet 42 is fixed to the lower surface of the base portion 12 (step S12). The insulation sheet is fixed to the base portion 12 through, for example, the adhesive layer as described above. Next, the lower sheet 41 is fixed to the lower surface of the insulation sheet 42 (step S13). The lower sheet 41 is also fixed to the insulation sheet 42 through, for example, the adhesive layer as described above. At step S13, the lower sheet 41 is fixed to the insulation sheet 42 such that a portion of the lower surface of the insulation sheet 42 is not covered with the lower sheet 41. Note that step S13 may alternatively be performed before step S12 or in parallel with step S12.

After steps S12 and S13 are completed, the initial electrode workpiece 30 is attached to the base portion 12. The circuit board 13 is fixed to the base portion 12 in advance. The initial electrode workpiece 30 is attached to the base portion 12 with the lower sheet 41 and the insulation sheet 42 therebetween. That is, the initial electrode workpiece 30 is attached to the base portion 12 such that each of the first and second motor electrode portions 31 and 32 projects downward relative to the lower surface of the base portion 12.

When the initial electrode workpiece 30 is attached to the base portion 12, the initial electrode workpiece 30 makes contact with the lower surface of the lower sheet 41 and the lower surface of the insulation sheet 42. More specifically, the disk-shaped portion 311 of the first motor electrode portion 31 and the end portion of the arc-shaped portion 321 of the second motor electrode portion 32 on which the second board connection portion 324 is provided make contact with the lower surface of the lower sheet 41. In addition, the first laterally projecting portion 312 of the first motor electrode portion 31, an end portion of the arc-shaped portion 321 of the second motor electrode portion 32 on the opposite side with respect to the aforementioned end portion, and the second laterally projecting portion 322 of the second motor electrode portion 32 make contact with the lower surface of the insulation sheet 42.

Further, when the initial electrode workpiece 30 is attached to the base portion 12, each of the first and second upwardly projecting portions 313 and 323 passes through the insulation sheet 42, the base portion 12, and the circuit board 13 to project upwardly of the circuit board 13. Then, each of the first and second upwardly projecting portions 313 and 323 is connected to the circuit board 13 through, for example, soldering. Each of the first and second motor electrode portions 31 and 32 is thus electrically connected to the circuit board 13 (step S14).

After each of the first and second motor electrode portions 31 and 32 is connected to the circuit board 13, the support member 35 is removed (step S15). At step S15, each of the junction of the first motor electrode portion 31 and the support member 35 and the junction of the second motor electrode portion 32 and the support member 35 is bent at the aforementioned groove portion or the like, for example, so that the support member 35 is separated from each of the first and second motor electrode portions 31 and 32. The removal of the support member 35 is carried out by, for example, a worker holding the support member 35 and bending each junction. Note that the removal of the support member 35 may alternatively be carried out by any other desirable method.

Thereafter, with the rotating portion, including the magnet portion 17 and so on, attached to the stationary portion, including the base portion 12 and so on, the cover portion 11 is fixed to the outer edge portion of the base portion 12 (step S16). The fixing of the cover portion 11 to the base portion 12 is performed with the entire base portion 12 and the entire circuit board 13 being arranged radially inside of the outer circumferential edge 113 of the cover portion lower end.

As described above, in the manufacture of the vibration motor 1, the initial electrode workpiece 30 is prepared first. The initial electrode workpiece 30 includes the first and second motor electrode portions 31 and 32 and the support member 35 arranged to support the first and second motor electrode portions 31 and 32. Next, the initial electrode workpiece 30 is attached to the base portion 12 such that each of the first and second motor electrode portions 31 and 32 projects downward relative to the lower surface of the base portion 12, and each of the first and second motor electrode portions 31 and 32 is electrically connected to the circuit board 13. Next, the support member 35 is removed. Then, the cover portion 11 is fixed to the outer edge portion of the base portion 12 with the entire base portion 12 and the entire circuit board 13 being arranged inside of the outer circumferential edge 113 of the cover portion lower end. Thus, the motor electrode portion 3 can be attached to the base portion 12 more easily than in the case where the first and second motor electrode portions 31 and 32 are dealt with separately.

In addition, in the manufacture of the vibration motor 1, the insulation sheet 42 is fixed to the lower surface of the base portion 12 before the above-described step S14. In addition, before the above-described step S14, the lower sheet 41 is fixed to the lower surface of the insulation sheet 42 such that a portion of the lower surface of the insulation sheet 42 is not covered with the lower sheet 41. Then, at step S14, when the initial electrode workpiece 30 is attached to the base portion 12, the initial electrode workpiece 30 makes contact with the lower surface of the lower sheet 41 and the lower surface of the insulation sheet 42. Thus, the motor electrode portion 3 can be easily attached to the base portion 12 with the lower sheet 41 and the insulation sheet 42 therebetween.

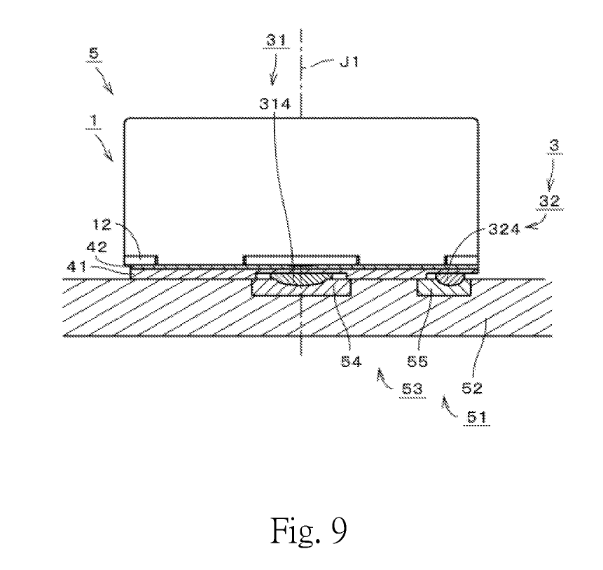

FIG. 9 is a sectional view illustrating a vibrator-attached board 5. The vibrator-attached board 5 includes the above-described vibration motor 1 and a target board 51. The vibration motor 1 is attached to the target board 51. The vibrator-attached board 5 is included in, for example, the aforementioned silent notification device. Regarding a part of the vibration motor 1 which lies above the lower surface of the base portion 12, only a side surface thereof is shown in FIG. 9. Regarding a part of the vibration motor 1 which lies below the lower surface of the base portion 12, a section thereof which is different in circumferential position from the section illustrated in FIG. 2 is shown in FIG. 9.

The target board 51 includes a board body 52 and a board electrode portion 53. The board body 52 is, for example, a member substantially in the shape of a plate. The board electrode portion 53 is arranged on an upper surface of the board body 52. The board electrode portion 53 is arranged to make contact with the motor electrode portion 3 of the vibration motor 1. The vibration motor 1 and the target board 51 are thus electrically connected to each other. The board electrode portion 53 includes a first board electrode portion 54 and a second board electrode portion 55. The first board electrode portion 54 is arranged to make contact with the first board connection portion 314 of the first motor electrode portion 31. The second board electrode portion 55 is arranged to make contact with the second board connection portion 324 of the second motor electrode portion 32.

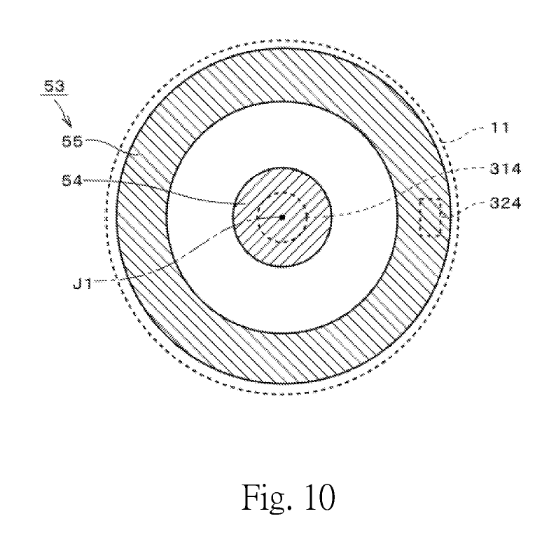

FIG. 10 is a plan view illustrating the first and second board electrode portions 54 and 55 of the board electrode portion 53. In FIG. 10, each of the first and second board electrode portions 54 and 55 is hatched with parallel oblique lines. In FIG. 10, each of the cover portion 11 and the first and second board connection portions 314 and 324 of the vibration motor 1 is represented by a broken line. The first board electrode portion 54 is, for example, substantially circular in a plan view. The second board electrode portion 55 is substantially annular, and is arranged to surround a circumference of the first board electrode portion 54 with a radial gap between the first and second board electrode portions 54 and 55 in a plan view. The second board electrode portion 55 is, for example, substantially in the shape of a circular ring in a plan view.

When the vibration motor 1 is attached to the target board 51, an adhesive layer is arranged on an upper surface of the cover portion 11 of the vibration motor 1, for example, and the vibration motor 1 is fixed to an inner surface of a case of a device, such as, for example, the mobile communication apparatus, through the adhesive layer. Then, the target board 51 is brought into contact with the lower surface of the vibration motor 1, and the target board 51 is pressed against the vibration motor 1 to be fixed to the case. The vibration motor 1 is thus attached to the target board 51.

At this time, the first board electrode portion 54 is arranged opposite to the first board connection portion 314 of the first motor electrode portion 31 in the vertical direction, and is brought into contact with the first board connection portion 314. As a result, the first motor electrode portion 31 and the first board electrode portion 54 are electrically connected to each other. In addition, the second board electrode portion 55 is arranged at the same radial position as that of the second board connection portion 324 of the second motor electrode portion 32, and is brought into contact with the second board connection portion 324. As a result, the second motor electrode portion 32 and the second board electrode portion 55 are electrically connected to each other.

When the vibration motor 1 is attached to the target board 51, the lower sheet 41 of the vibration motor 1 is elastically deformed in the vertical direction. More specifically, the lower sheet 41 is compressed in the vertical direction toward the base portion 12. Accordingly, the most part of the lower surface of the lower sheet 41 is brought into contact with an upper surface of the target board 51. In addition, the first board connection portion 314 protrudes downward from the lower sheet 41 relatively largely, and is strongly pressed against the first board electrode portion 54. As a result, the first motor electrode portion 31 is electrically connected to the first board electrode portion 54. In addition, the first board connection portion 314 is arranged below the lower sheet 41 to overlap with the lower sheet 41 when viewed in the vertical direction. Accordingly, the first board connection portion 314 is pressed against the first board electrode portion 54 with increased strength because of the lower sheet 41 being elastically deformed between the first board connection portion 314 and the base portion 12.

The second board connection portion 324 also protrudes downward from the lower sheet 41 relatively largely, and is strongly pressed against the second board electrode portion 55. As a result, the second motor electrode portion 32 is electrically connected to the second board electrode portion 55. In addition, the second board connection portion 324 is arranged below the lower sheet 41 to overlap with the lower sheet 41 when viewed in the vertical direction. Accordingly, the second board connection portion 324 is pressed against the second board electrode portion 55 with increased strength because of the lower sheet 41 being elastically deformed between the second board connection portion 324 and the base portion 12.

Note that the vibration motor 1 may be attached to the target board 51 of the vibrator-attached board 5 by any desirable method. For example, an adhesive layer may be arranged on the lower surface of the lower sheet 41 of the vibration motor 1, and the vibration motor 1 may be adhered to the upper surface of the target board 51 through this adhesive layer to attach the vibration motor 1 to the target board 51.

As described above, the vibrator-attached board 5 includes the above-described vibration motor 1 and the target board 51 to which the vibration motor 1 is attached. The target board 51 includes the board electrode portion 53 arranged to make contact with the motor electrode portion 3 of the vibration motor 1. The board electrode portion 53 includes the first and second board electrode portions 54 and 55.

The second board electrode portion 55 is an annular electrode portion arranged to surround the circumference of the first board electrode portion 54 with the radial gap between the first and second board electrode portions 54 and 55. This makes it possible to bring the motor electrode portion 3 into electrical connection with the board electrode portion 53 of the target board without the need for a precise consideration of the circumferential orientation of the vibration motor 1, when the vibration motor 1 is attached to the target board 51. As a result, the attachment of the vibration motor 1 to the target board 51 is made easier.

The first board electrode portion 54 of the target board 51 of the vibrator-attached board 5 is arranged to make contact with the first board connection portion 314 of the first motor electrode portion 31. The second board electrode portion 55 is arranged to make contact with the second board connection portion 324 of the second motor electrode portion 32. The second board connection portion 324 is arranged below the lower sheet 41 to overlap with the lower sheet 41 when viewed in the vertical direction. Thus, when the vibration motor 1 is attached to the target board 51, the portion of the lower sheet 41 which is arranged between the second board connection portion 324 and the base portion 12 is elastically deformed to make the vertical level of a lower end portion of the second board connection portion 324 approach the vertical level of the lower surface of the lower sheet 41. Thus, the lower surface of the lower sheet 41 easily makes contact with the target board 51 around the second board connection portion 324. As a result, the second board connection portion 324 of the second motor electrode portion 32 can be brought into stable contact with the second board electrode portion 55 of the target board 51.

As described above, the first board electrode portion 54 of the target board 51 is arranged opposite to the first board connection portion 314 of the first motor electrode portion 31 in the vertical direction, and is brought into contact with the first board connection portion 314. In addition, the second board electrode portion 55 of the target board 51 is arranged at the same radial position as that of the second board connection portion 324 of the second motor electrode portion 32, and is brought into contact with the second board connection portion 324. This makes it possible to bring the first board connection portion 314 of the first motor electrode portion 31 and the second board connection portion 324 of the second motor electrode portion 32 into electrical connection with the first and second board electrode portions 54 and 55, respectively, of the target board 51 without the need for a precise consideration of the circumferential orientation of the vibration motor 1, when the vibration motor 1 is attached to the target board 51. In other words, without the need for a precise consideration of the circumferential orientation of the vibration motor 1, the motor electrode portion 3 and the board electrode portion 53 of the target board 51 can be brought into electrical connection with each other. As a result, the attachment of the vibration motor 1 to the target board 51 is made easier.

In the vibration motor 1, the second motor electrode portion 32 includes the second board connection portion 324 and the second upwardly projecting portion 323. The second board connection portion 324 is arranged to make contact with the board electrode portion 53. The second upwardly projecting portion 323 is arranged to project upwardly of the circuit board 13 at a position circumferentially away from the second board connection portion 324, and is electrically connected to the circuit board 13. This allows the second upwardly projecting portion 323 to be easily connected to the circuit board 13 while allowing the second board connection portion 324 to be easily arranged at a desirable position.

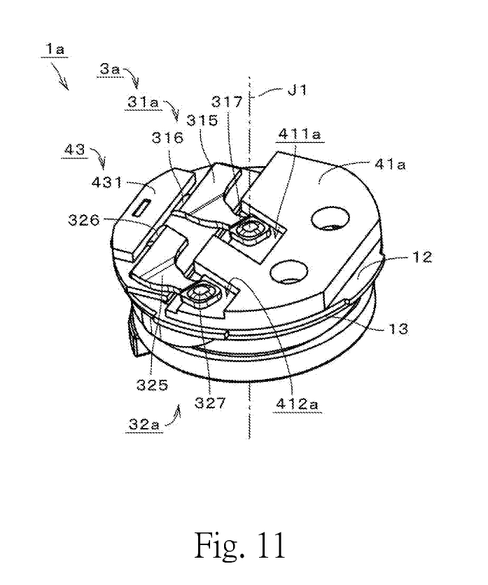

FIG. 11 is a perspective view of a rotating portion and a stationary portion of a vibration motor 1a according to a second preferred embodiment of the present invention as viewed from below. Similarly to the vibration motor 1, the vibration motor 1a is a brushless motor in the shape of a coin. In place of the vibration motor 1, the vibration motor 1a may be attached to the target board 51 of the vibrator-attached board 5 as illustrated in FIG. 9, for example. The vibration motor 1a is used in, for example, a silent notification device in a mobile communication apparatus, such as a cellular phone. In other words, the vibration motor 1a is included in the silent notification device, for example.

The vibration motor 1a includes a motor electrode portion 3a and a lower sheet 41a, which are different in shape from the motor electrode portion 3 and the lower sheet 41, respectively, of the vibration motor 1, instead of the motor electrode portion 3 and the lower sheet 41. In addition, the vibration motor 1a further includes an electrode holder 43. The insulation sheet 42 as illustrated in FIG. 5 is not provided in the vibration motor 1a. The vibration motor 1a is otherwise substantially similar in structure to the vibration motor 1. In the following description, members or portions of the vibration motor 1a that have their equivalents in the vibration motor 1 will be designated by the same reference numerals as those of their equivalents in the vibration motor 1.

The motor electrode portion 3a is arranged to project below a lower surface of a base portion 12. The motor electrode portion 3a includes a first motor electrode portion 31a and a second motor electrode portion 32a. The second motor electrode portion 32a has substantially the same shape as that of the first motor electrode portion 31a in a plan view. Each of the first and second motor electrode portions 31a and 32a is, for example, substantially in the shape of the letter “L” in a plan view. Each of the first and second motor electrode portions 31a and 32a is arranged radially inside of an outer circumferential edge 113 of a cover portion lower end (see FIG. 1). The first motor electrode portion 31a is arranged on a central axis J1. The second motor electrode portion 32a is arranged on the lateral side of the first motor electrode portion 31a with a gap therebetween.

The lower sheet 41a is a sheet-shaped member that is elastically deformable. The lower sheet 41a is made of, for example, silicone rubber. Note that the lower sheet 41a may alternatively be made of any other desirable insulating material. The lower sheet 41a is attached to the lower surface of the base portion 12 around the motor electrode portion 3a. The lower sheet 41a is fixed to the base portion 12 through, for example, an adhesive layer. The entire lower sheet 41a is arranged radially inside of the outer circumferential edge 113 of the cover portion lower end. The lower sheet 41a is, for example, substantially in the shape of a semicircle in a plan view. The radius of the lower sheet 41a is substantially equal to the radius of the base portion 12. A portion of the lower sheet 41a is arranged between the motor electrode portion 3a and the base portion 12. Another portion of the lower sheet 41a is arranged around the motor electrode portion 3a.

The electrode holder 43 is made of an insulating material. The electrode holder 43 is a relatively hard insulating member. The electrode holder 43 is attached to the lower surface of the base portion 12. For example, a projecting portion that projects downward from the lower surface of the base portion 12 is press fitted into a through hole or a recessed portion defined in the electrode holder 43 to fix the electrode holder 43 to the base portion 12. The electrode holder 43 is arranged on the lateral side of the lower sheet 41a below the base portion 12. The electrode holder 43 is, for example, arranged adjacent to the lower sheet 41a with a gap therebetween. The motor electrode portion 3a is fixed to a lower surface of the electrode holder 43. The electrode holder 43 includes a holder projecting portion 431 arranged to project downward on the lateral side of the motor electrode portion 3a.

The first motor electrode portion 31a includes a first electrode base portion 315 and a first upwardly projecting portion 316. The first electrode base portion 315 and the first upwardly projecting portion 316 are defined by a single continuous monolithic member. The first electrode base portion 315 is a portion substantially in the shape of the letter “L” in a plan view. A first board connection portion 317 is provided on a lower surface of one end portion of the first electrode base portion 315. The first board connection portion 317 is arranged to project downward from the lower surface of the above end portion of the first electrode base portion 315. The first board connection portion 317 is, for example, arranged on the central axis J1. The first upwardly projecting portion 316 is arranged to project upward from a portion of the first electrode base portion 315 which is away from the first board connection portion 317. The first upwardly projecting portion 316 is, for example, arranged on a substantially straight portion of the first electrode base portion 315, which is substantially in the shape of the letter “L”, an end portion of the substantially straight portion not being provided with the first board connection portion 317. The first upwardly projecting portion 316 is arranged to pass through the electrode holder 43, the base portion 12, and a circuit board 13 to project upwardly of the circuit board 13. A portion of the first upwardly projecting portion 316 which projects upwardly of the circuit board 13 is electrically connected to an upper surface of the circuit board 13 through, for example, soldering.

For example, the first upwardly projecting portion 316 is press fitted from below into a through hole defined in the electrode holder 43 to fix the first motor electrode portion 31a to the lower surface of the electrode holder 43. The first motor electrode portion 31a is thus stably fixed to the electrode holder 43. Note that the first motor electrode portion 31a may alternatively be fixed to the electrode holder 43 through, for example, an adhesive layer without being press fitted thereto. A remaining portion of the first electrode base portion 315 excluding the end portion thereof on which the first board connection portion 317 is provided is arranged below the electrode holder 43, and is arranged to be in contact with the lower surface of the electrode holder 43. The end portion (hereinafter referred to as a “connection end portion”) of the first electrode base portion 315 on which the first board connection portion 317 is provided is arranged to project laterally and downwardly relative to the electrode holder 43. That is, the first board connection portion 317 is arranged to project laterally and downwardly relative to the electrode holder 43, and is arranged at a level lower than that of the other portion of the first electrode base portion 315.

The connection end portion of the first electrode base portion 315 is arranged below the lower sheet 41a, and is arranged to be in contact with a lower surface of the lower sheet 41a. That is, the first board connection portion 317 is arranged below the lower sheet 41a to overlap with the lower sheet 41a when viewed in the vertical direction. A portion of the lower sheet 41a which makes contact with the first electrode base portion 315 and an adjacent portion thereof together define a sheet recessed portion 411a of the lower sheet 41a, which is recessed upward relative to another portion of the lower sheet 41a. In other words, a lower surface of the sheet recessed portion 411a of the lower sheet 41a, which is arranged between the first electrode base portion 315 and the base portion 12, is arranged at a level higher than that of a lower surface of a portion of the lower sheet 41a which is around the sheet recessed portion 411a. A lower end portion of the first board connection portion 317 is arranged, for example, at a vertical level substantially the same as or lower than that of the lower surface of the portion of the lower sheet 41a which is around the sheet recessed portion 411a.

The second motor electrode portion 32a includes a second electrode base portion 325 and a second upwardly projecting portion 326. The second electrode base portion 325 and the second upwardly projecting portion 326 are defined by a single continuous monolithic member. The second electrode base portion 325 is a portion substantially in the shape of the letter “L” in a plan view. A second board connection portion 327 is provided on a lower surface of one end portion of the second electrode base portion 325. The second board connection portion 327 is arranged to project downward from the lower surface of the above end portion of the second electrode base portion 325. The second board connection portion 327 is arranged on the lateral side of the first board connection portion 317. The second upwardly projecting portion 326 is arranged to project upward from a portion of the second electrode base portion 325 which is away from the second board connection portion 327. The second upwardly projecting portion 326 is, for example, arranged on a substantially straight portion of the second electrode base portion 325, which is substantially in the shape of the letter “L”, an end portion of the substantially straight portion not being provided with the second board connection portion 327. The second upwardly projecting portion 326 is arranged to pass through the electrode holder 43, the base portion 12, and the circuit board 13 to project upwardly of the circuit board 13. A portion of the second upwardly projecting portion 326 which projects upwardly of the circuit board 13 is electrically connected to the upper surface of the circuit board 13 through, for example, soldering. In the preferred embodiment illustrated in FIG. 11, the shape of the second motor electrode portion 32a is the same as the shape of the first motor electrode portion 31a except that the position of the second upwardly projecting portion 326 is different from the position of the first upwardly projecting portion 316.

For example, the second upwardly projecting portion 326 is press fitted from below into a through hole defined in the electrode holder 43 to fix the second motor electrode portion 32a to the lower surface of the electrode holder 43. The second motor electrode portion 32a is thus stably fixed to the electrode holder 43. Note that the second motor electrode portion 32a may alternatively be fixed to the electrode holder 43 through, for example, an adhesive layer without being press fitted thereto. A remaining portion of the second electrode base portion 325 excluding the end portion thereof on which the second board connection portion 327 is provided is arranged below the electrode holder 43, and is arranged to be in contact with the lower surface of the electrode holder 43. The end portion (hereinafter referred to as a “connection end portion”) of the second electrode base portion 325 on which the second board connection portion 327 is provided is arranged to project laterally and downwardly relative to the electrode holder 43. That is, the second board connection portion 327 is arranged to project laterally and downwardly relative to the electrode holder 43, and is arranged at a level lower than that of the other portion of the second electrode base portion 325.

The connection end portion of the second electrode base portion 325 is arranged below the lower sheet 41a, and is arranged to be in contact with the lower surface of the lower sheet 41a. That is, the second board connection portion 327 is arranged below the lower sheet 41a to overlap with the lower sheet 41a when viewed in the vertical direction. A portion of the lower sheet 41a which makes contact with the second electrode base portion 325 and an adjacent portion thereof together define a sheet recessed portion 412a of the lower sheet 41a, which is recessed upward relative to another portion of the lower sheet 41a. In other words, a lower surface of the sheet recessed portion 412a of the lower sheet 41a, which is arranged between the second electrode base portion 325 and the base portion 12, is arranged at a level higher than that of a lower surface of a portion of the lower sheet 41a which is around the sheet recessed portion 412a. A lower end portion of the second board connection portion 327 is arranged, for example, at a vertical level substantially the same as or lower than that of the lower surface of the portion of the lower sheet 41a which is around the sheet recessed portion 412a.

The substantially straight portion of the second electrode base portion 325 the end portion of which is not provided with the second board connection portion 327 is arranged to be, for example, in alignment with the substantially straight portion of the first electrode base portion 315 the end portion of which is not provided with the first board connection portion 317. The holder projecting portion 431 of the electrode holder 43 is arranged on the opposite side of the substantially straight portion of the first electrode base portion 315 and the substantially straight portion of the second electrode base portion 325 with respect to the lower sheet 41a. In other words, each of the remaining portion of the first electrode base portion 315 excluding the connection end portion thereof, and the remaining portion of the second electrode base portion 325 excluding the connection end portion thereof is arranged between the lower sheet 41a and the holder projecting portion 431.

As described above, the vibration motor 1a includes the motor electrode portion 3a electrically connected to the circuit board 13. The motor electrode portion 3a is arranged to project below the lower surface of the base portion 12. The entire base portion 12 and the entire circuit board 13 are arranged inside of the outer circumferential edge 113 of the cover portion lower end. Thus, a portion projecting radially outward from the cover portion 11 can be eliminated. This contributes to reducing the radial dimension of the vibration motor 1a.

In the vibration motor 1a, the outer circumferential edge 113 of the cover portion lower end is circular. In addition, the base portion 12 is substantially in the shape of a disk. The shape of the vibration motor 1a can thus be simplified. In addition, a reduction in the radial dimension of the vibration motor 1a can thus be achieved.

The vibration motor 1a further includes the lower sheet 41a, which is in the shape of a sheet and is elastically deformable. The lower sheet 41a is attached to the lower surface of the base portion 12 around the motor electrode portion 3a. Thus, when a lower surface of the vibration motor 1a is brought into contact with a target object, such as a board, to attach the vibration motor 1a to the target object, the lower sheet 41a is elastically deformed in accordance with the surface shape of the target object. This allows the motor electrode portion 3a to make stable contact with an electrode portion of the target object while minimizing tilting of the vibration motor 1a with respect to the target object. This in turn leads to accomplishing a stable electrical connection between the vibration motor 1a and the target object without use of a solder or the like.

As described above, a portion of the lower sheet 41a is arranged between the motor electrode portion 3a and the base portion 12. Thus, when the vibration motor 1a is attached to the target object, the portion of the lower sheet 41a which is arranged between the motor electrode portion 3a and the base portion 12 is elastically deformed to make the vertical level of a lower end portion of the motor electrode portion 3a approach the vertical level of the lower surface of the lower sheet 41a. Thus, the lower surface of the lower sheet 41a easily makes contact with the target object around the motor electrode portion 3a. As a result, the motor electrode portion 3a can be brought into more stable contact with the electrode portion of the target object.

In the vibration motor 1a, the first board connection portion 317 of the first motor electrode portion 31a is arranged on the central axis J1. In addition, in the vibration motor 1a, a portion of the lower sheet 41a which is arranged between the first motor electrode portion 31a and the base portion 12 defines the sheet recessed portion 411a, which is recessed upward relative to another portion of the lower sheet 41a. This allows the vertical level of a lower end portion of the first motor electrode portion 31a arranged on the sheet recessed portion 411a to easily approach the vertical level of the lower surface of the portion of the lower sheet 41a which is around the sheet recessed portion 411a. Thus, the lower surface of the lower sheet 41a easily makes contact with the target object around the first motor electrode portion 31a. As a result, the first motor electrode portion 31a can be brought into stable contact with the electrode portion of the target object.

As described above, the vibration motor 1a further includes the electrode holder 43. The electrode holder 43 is attached to the lower surface of the base portion 12. The motor electrode portion 3a is fixed to the lower surface of the electrode holder 43. This prevents a direct contact between the motor electrode portion 3a and the base portion 12. In addition, the electrode holder 43 is arranged on the lateral side of the lower sheet 41a below the base portion 12. The vertical dimension of the vibration motor 1a is thus made smaller than in the case where the lower sheet 41a and the electrode holder 43 are arranged to overlap with each other when viewed in the vertical direction.

In the vibration motor 1a, the electrode holder 43 includes the holder projecting portion 431 arranged to project downward on the lateral side of the motor electrode portion 3a. The holder projecting portion 431 is arranged to make contact with the target object to maintain a situation in which remaining portions of the motor electrode portion 3a excluding the first and second board connection portions 317 and 327 are spaced from the target object. This contributes to preventing the remaining portions of the motor electrode portion 3a excluding the first and second board connection portions 317 and 327 from making contact with the electrode portion of the target object even in the case where the motor electrode portion 3a is fixed while being slightly spaced downward from the lower surface of the electrode holder 43. In addition, each of the remaining portion of the first electrode base portion 315 excluding the connection end portion thereof, and the remaining portion of the second electrode base portion 325 excluding the connection end portion thereof is arranged between the lower sheet 41a and the holder projecting portion 431. This contributes to more effectively preventing the remaining portions of the motor electrode portion 3a excluding the first and second board connection portions 317 and 327 from making contact with the electrode portion of the target object.

As described above, the second motor electrode portion 32a has substantially the same shape as that of the first motor electrode portion 31a in a plan view. This simplifies manufacture of the motor electrode portion 3a. In addition, the substantially straight portion of the second electrode base portion 325 the end portion of which is not provided with the second board connection portion 327 is arranged to be in alignment with the substantially straight portion of the first electrode base portion 315 the end portion of which is not provided with the first board connection portion 317. Further, the first upwardly projecting portion 316 is arranged on the substantially straight portion of the first electrode base portion 315, and the second upwardly projecting portion 326 is arranged on the substantially straight portion of the second electrode base portion 325. Thus, a junction of the first motor electrode portion 31a and the circuit board 13, and a junction of the second motor electrode portion 32a and the circuit board 13 can be arranged in proximity to each other. This makes it possible to easily achieve isolation between the motor electrode portion 3a and the base portion 12 by use of the electrode holder 43.

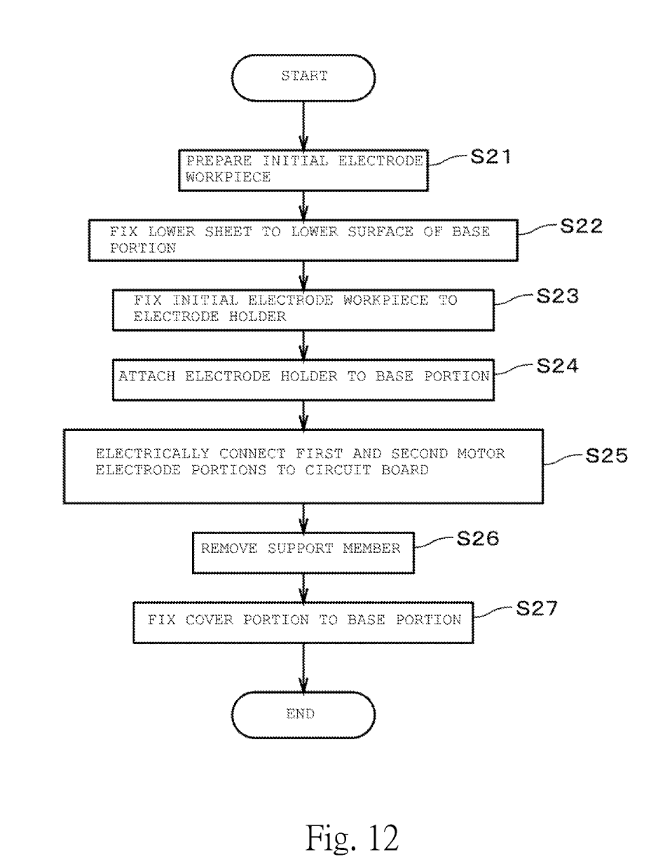

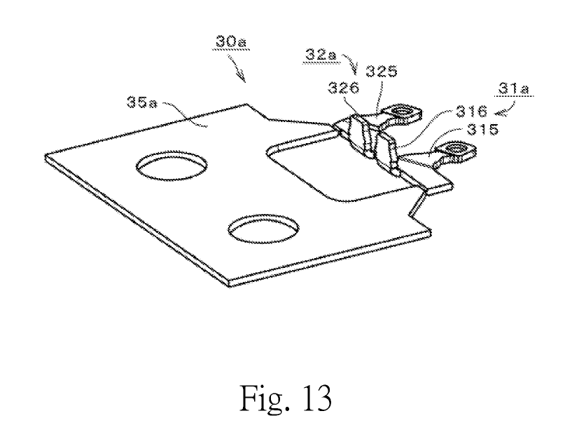

FIG. 12 is a flowchart illustrating an example procedure for manufacturing the vibration motor 1a. At step S21, an initial electrode workpiece 30a as illustrated in FIG. 13 is prepared. The initial electrode workpiece 30a includes the first and second motor electrode portions 31a and 32a and a support member 35a. The support member 35a is arranged to support the first and second motor electrode portions 31a and 32a. The first and second motor electrode portions 31a and 32a and the support member 35a are defined by a single continuous monolithic member. In the preferred embodiment illustrated in FIG. 13, the support member 35a is connected to a portion of the first electrode base portion 315 of the first motor electrode portion 31a, the portion being adjacent to the first upwardly projecting portion 316. In addition, the support member 35a is also connected to a portion of the second electrode base portion 325 of the second motor electrode portion 32a, the portion being adjacent to the second upwardly projecting portion 326. A groove portion, for example, is defined in each of a junction of the support member 35a and the first motor electrode portion 31a and a junction of the support member 35a and the second motor electrode portion 32a. Therefore, the strength of each of these junctions is lower than the strength of other portions of the initial electrode workpiece 30a.

Next, the lower sheet 41a is fixed to the lower surface of the base portion 12 (step S22). The lower sheet 41a is fixed to the base portion 12 through, for example, the adhesive layer as described above.

Next, the first and second motor electrode portions 31a and 32a of the initial electrode workpiece 30a are fixed to the electrode holder 43 (step S23). Then, the electrode holder 43, with the initial electrode workpiece 30a attached thereto, is attached to the lower surface of the base portion 12 (step S24). The fixing of the electrode holder 43 to the base portion 12 is accomplished by, for example, press fitting the projecting portion of the base portion 12 into the through hole or the recessed portion of the electrode holder 43, as described above. As a result, each of the first and second motor electrode portions 31a and 32a is indirectly fixed to the base portion 12 with the electrode holder 43 therebetween. The first and second motor electrode portions 31a and 32a are attached to the base portion 12 such that each of the first and second motor electrode portions 31a and 32a projects downward relative to the lower surface of the base portion 12.

At step S23, the first upwardly projecting portion 316 of the first motor electrode portion 31a is press fitted into the corresponding through hole of the electrode holder 43 as described above. In addition, the second upwardly projecting portion 326 of the second motor electrode portion 32a is press fitted into the corresponding through hole of the electrode holder 43. Each of the first and second motor electrode portions 31a and 32a can thus be stably fixed to the electrode holder 43. As a result, each of the first and second motor electrode portions 31a and 32a can be stably fixed to the base portion 12 at step S24. Note that step S23 may alternatively be performed before step S22 or in parallel with step S22.

When the electrode holder 43 is attached to the base portion 12 at step S24, each of the connection end portion of the first motor electrode portion 31a and the connection end portion of the second motor electrode portion 32a is brought into contact with the lower surface of the lower sheet 41a. In addition, each of the first and second upwardly projecting portions 316 and 326 is passed through the base portion 12 and the circuit board 13 to project upwardly of the circuit board 13. Then, each of the first and second upwardly projecting portions 316 and 326 is connected to the circuit board 13 through, for example, soldering. Each of the first and second motor electrode portions 31a and 32a is thus electrically connected to the circuit board 13 (step S25).

After each of the first and second motor electrode portions 31a and 32a is connected to the circuit board 13, the support member 35a is removed (step S26). At step S26, each of the junction of the first motor electrode portion 31a and the support member 35a and the junction of the second motor electrode portion 32a and the support member 35a is bent at the aforementioned groove portion or the like, for example, so that the support member 35a is separated from each of the first and second motor electrode portions 31a and 32a. The removal of the support member 35a is carried out by, for example, a worker holding the support member 35a and bending each junction. Note that the removal of the support member 35a may alternatively be carried out by any other desirable method.

Thereafter, with the rotating portion, including a magnet portion 17 and so on, attached to the stationary portion, including the base portion 12 and so on, a cover portion 11 is fixed to an outer edge portion of the base portion 12 (step S27). The fixing of the cover portion 11 to the base portion 12 is performed with the entire base portion 12 and the entire circuit board 13 being arranged radially inside of the outer circumferential edge 113 of the cover portion lower end.

As described above, in the manufacture of the vibration motor 1a, the initial electrode workpiece 30a is prepared first. The initial electrode workpiece 30a includes the first and second motor electrode portions 31a and 32a and the support member 35a arranged to support the first and second motor electrode portions 31a and 32a. Next, the initial electrode workpiece 30a is attached to the base portion 12 such that each of the first and second motor electrode portions 31a and 32a projects downward relative to the lower surface of the base portion 12, and each of the first and second motor electrode portions 31a and 32a is electrically connected to the circuit board 13. Next, the support member 35a is removed. Then, the cover portion 11 is fixed to the outer edge portion of the base portion 12 with the entire base portion 12 and the entire circuit board 13 being arranged inside of the outer circumferential edge 113 of the cover portion lower end. Thus, the motor electrode portion 3a can be attached to the base portion 12 more easily than in the case where the first and second motor electrode portions 31a and 32a are dealt with separately.

In addition, in the manufacture of the vibration motor 1a, the first and second motor electrode portions 31a and 32a of the initial electrode workpiece 30a are fixed to the electrode holder 43 (step S23) between the above-described steps S21 and S24. Then, at step S24, the electrode holder 43 is attached to the lower surface of the base portion 12, so that the initial electrode workpiece 30a is attached to the base portion 12. The attachment of the motor electrode portion 3a to the base portion 12 can thus be achieved easily and stably.

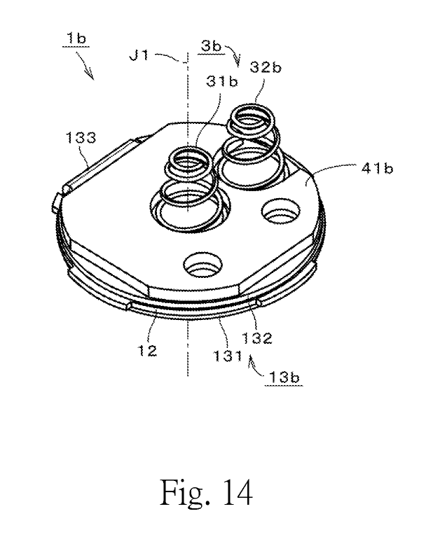

FIG. 14 is a perspective view illustrating a portion of a stationary portion of a vibration motor 1b according to a third preferred embodiment of the present invention as viewed from below. Similarly to the vibration motor 1, the vibration motor 1b is a brushless motor in the shape of a coin. In place of the vibration motor 1, the vibration motor 1b may be attached to the target board 51 of the vibrator-attached board 5 as illustrated in FIG. 9, for example. The vibration motor 1b is used in, for example, a silent notification device in a mobile communication apparatus, such as a cellular phone. In other words, the vibration motor 1b is included in the silent notification device, for example.

The vibration motor 1b includes a circuit board 13b, a motor electrode portion 3b, and a lower sheet 41b which are different in shape from the circuit board 13, the motor electrode portion 3, and the lower sheet 41, respectively, of the vibration motor 1, instead of the circuit board 13, the motor electrode portion 3, and the lower sheet 41. In FIG. 14, a base portion 12, the circuit board 13b, the motor electrode portion 3b, and the lower sheet 41b of the vibration motor 1b are shown. The vibration motor 1b is otherwise substantially similar in structure to the vibration motor 1. In the following description, members or portions of the vibration motor 1b that have their equivalents in the vibration motor 1 will be designated by the same reference numerals as those of their equivalents in the vibration motor 1.

The motor electrode portion 3b is arranged to project below a lower surface of the base portion 12. The motor electrode portion 3b includes a first motor electrode portion 31b and a second motor electrode portion 32b. The first motor electrode portion 31b is defined by a coil spring having a central axis extending in the vertical direction. The second motor electrode portion 32b is also defined by a coil spring having a central axis extending in the vertical direction. Each of the first and second motor electrode portions 31b and 32b is arranged radially inside of an outer circumferential edge 113 of a cover portion lower end (see FIG. 1). The first motor electrode portion 31b is arranged on a central axis J1. The second motor electrode portion 32b is arranged on the lateral side of the first motor electrode portion 31b with a gap therebetween.

In the preferred embodiment illustrated in FIG. 14, each of the first and second motor electrode portions 31b and 32b has substantially the same shape. Each of the first and second motor electrode portions 31b and 32b is, for example, substantially in the shape of a truncated cone, gradually decreasing in a diameter with increasing distance from the base portion 12. Note that the shape of each of the first and second motor electrode portions 31b and 32b may be modified in various manners. For example, each of the first and second motor electrode portions 31b and 32b may alternatively be substantially columnar, having a constant diameter at any vertical position.

The circuit board 13b is a flexible board, which has flexibility. The circuit board 13b includes a first circuit board 131, a second circuit board 132, and a connection portion 133. The first and second circuit boards 131 and 132 and the connection portion 133 are defined by a single continuous monolithic member. The circuit board 13b is bent at the connection portion 133, so that the first and second circuit boards 131 and 132 are arranged one above the other in the vertical direction with the base portion 12 therebetween.

The first circuit board 131 is arranged on an upper surface of the base portion 12. The second circuit board 132 is arranged on the lower surface of the base portion 12. The connection portion 133 is arranged on the lateral side of the base portion 12 to connect the first and second circuit boards 131 and 132 to each other. The second circuit board 132 is electrically connected to the first circuit board 131 through, for example, a wire arranged at the connection portion 133. Each of the first and second circuit boards 131 and 132 is, for example, substantially circular in a plan view. Each of the first and second circuit boards 131 and 132 is arranged to have a radius substantially equal to that of the base portion 12. That is, the first circuit board 131 is arranged to cover substantially the entire upper surface of the base portion 12. In addition, the second circuit board 132 is arranged to cover substantially the entire lower surface of the base portion 12. Each of the first and second motor electrode portions 31b and 32b is fixed to a lower surface of the second circuit board 132 through, for example, soldering or the like, and is electrically connected to the second circuit board 132.

The lower sheet 41b is a sheet-shaped member that is elastically deformable. The lower sheet 41b is made of, for example, silicone rubber. Note that the lower sheet 41b may alternatively be made of any other desirable insulating material. The lower sheet 41b is fixed to the lower surface of the second circuit board 132 below the base portion 12. That is, the lower sheet 41b is indirectly attached to the lower surface of the base portion 12 with the second circuit board 132 therebetween. The lower sheet 41b is fixed to the second circuit board 132 through, for example, an adhesive layer.

The entire lower sheet 41b is arranged radially inside of the outer circumferential edge 113 of the cover portion lower end. The lower sheet 41b is, for example, substantially circular in a plan view. The radius of the lower sheet 41b is substantially equal to the radius of the base portion 12. The lower sheet 41b is arranged around the motor electrode portion 3b. More specifically, a through hole and a cut portion are defined in the lower sheet 41b, and the first and second motor electrode portions 31b and 32b are arranged in the through hole and the cut portion, respectively. A lower surface of the lower sheet 41b is arranged at a level higher than that of each of a lower end of the first motor electrode portion 31b and a lower end of the second motor electrode portion 32b.

As described above, the vibration motor 1b includes the motor electrode portion 3b electrically connected to the circuit board 13b. The motor electrode portion 3b is arranged to project below the lower surface of the base portion 12. The entire base portion 12 and the entire circuit board 13b are arranged inside of the outer circumferential edge 113 of the cover portion lower end. Thus, a portion projecting radially outward from a cover portion 11 can be eliminated. This contributes to reducing the radial dimension of the vibration motor 1b. Note that, in the vibration motor 1b, a small portion of the circuit board 13b, such as, for example, a radially outer end portion of the connection portion 133, may be outside of the outer circumferential edge 113 of the cover portion lower end, as long as the entire circuit board 13b is arranged substantially inside of the outer circumferential edge 113 of the cover portion lower end.

In the vibration motor 1b, the outer circumferential edge 113 of the cover portion lower end is circular. In addition, the base portion 12 is substantially in the shape of a disk. The shape of the vibration motor 1b can thus be simplified. In addition, a reduction in the radial dimension of the vibration motor 1b can thus be achieved.

As described above, the motor electrode portion 3b includes the first and second motor electrode portions 31b and 32b, each of which is defined by a coil spring. The structure of each of the first and second motor electrode portions 31b and 32b is thus simplified. In addition, when the vibration motor 1b is attached to a target object, such as a board, each of the first and second motor electrode portions 31b and 32b is elastically deformed in the vertical direction in accordance with the surface shape of the target object. This allows the motor electrode portion 3b to make stable contact with an electrode portion of the target object while minimizing tilting of the vibration motor 1b with respect to the target object. This in turn leads to accomplishing a stable electrical connection between the vibration motor 1b and the target object without use of a solder or the like.

As described above, each of the first and second motor electrode portions 31b and 32b is substantially in the shape of a truncated cone. Thus, the vertical height of each of the first and second motor electrode portions 31b and 32b in a state of being compressed in the vertical direction can be made small. This contributes to reducing the vertical dimension of the vibration motor 1b attached to the target object.

The vibration motor 1b further includes the lower sheet 41b, which is in the shape of a sheet and is elastically deformable. The lower sheet 41b is attached to the lower surface of the base portion 12 around the motor electrode portion 3b. Thus, when a lower surface of the vibration motor 1b is brought into contact with the target object, such as a board, to attach the vibration motor 1b to the target object, the lower sheet 41b is elastically deformed in accordance with the surface shape of the target object. This allows the motor electrode portion 3b to make more stable contact with the electrode portion of the target object while more effectively minimizing the tilting of the vibration motor 1b with respect to the target object. This in turn leads to accomplishing a stable electrical connection between the vibration motor 1b and the target object without use of a solder or the like.

As described above, the circuit board 13b includes the first and second circuit boards 131 and 132. The first circuit board 131 is arranged on the upper surface of the base portion 12. The second circuit board 132 is electrically connected to the first circuit board 131, and is arranged on the lower surface of the base portion 12. Each of the first and second motor electrode portions 31b and 32b is connected to the second circuit board 132. Thus, the need to define a through hole for connecting the motor electrode portion 3b and the circuit board 13b to each other in the base portion 12 is eliminated. This leads to a simpler structure of the base portion 12. In addition, the motor electrode portion 3b can be connected to the circuit board 13b in, for example, a reflow process or the like for the circuit board 13b, before the circuit board 13b is fixed to the base portion 12. This leads to simplifying manufacture of the vibration motor 1b.

In the vibration motor 1b, the circuit board 13b further includes the connection portion 133. The connection portion 133 is arranged on the lateral side of the base portion 12 to connect the first and second circuit boards 131 and 132 to each other. Handling of each of the first and second circuit boards 131 and 132 is thus made easier. In addition, the attachment of each of the first and second circuit boards 131 and 132 to the base portion 12 can be simplified. Further, the electrical connection between the first and second circuit boards 131 and 132 can be easily accomplished through the connection portion 133. Note that the first and second circuit boards 131 and 132 of the circuit board 13b may alternatively be defined by separate members with the connection portion 133 being omitted. In this case, the first and second circuit boards 131 and 132 are electrically connected to each other through, for example, a through hole defined in the base portion 12.

Note that each of the vibration motors 1, 1a, and 1b, the vibrator-attached board 5, the silent notification device, and the methods for manufacturing the vibration motors 1, 1a, and 1b described above may be modified in various manners.

In each of the vibration motors 1, 1a, and 1b, the shape, structure, arrangement, or the like of each of the coil portion 14, the shaft 15, the rotor holder 16, the magnet portion 17, the eccentric weight 18, the bearing portion 21, the spacer 22, and so on may be modified in various manners. For example, the spacer 22 may alternatively be arranged radially inside of the coil 141 and be arranged radially opposite to the coil 141.

Also, in each of the vibration motors 1, 1a, and 1b, the coil portion 14 may alternatively include a plurality of coils. In this case, the plurality of coils are attached to the circuit board 13 around the shaft 15, and are each arranged radially opposite to the shaft 15 with a gap therebetween.

In each of the vibration motors 1, 1a, and 1b, the outer circumferential edge 113 of the cover portion lower end may alternatively be in any desirable shape other than a circle, and the base portion 12 may alternatively be in any desirable shape other than the shape of a disk, as long as the entire base portion and the entire circuit board 13 or 13b are arranged substantially inside of the outer circumferential edge 113 of the cover portion lower end.

In each of the motor electrode portions 3, 3a, and 3b of the vibration motors 1, 1a, and 1b, respectively, the shape and arrangement of each of the first motor electrode portion 31, 31a, or 31b and the second motor electrode portion 32, 32a, or 32b may be modified in various manners. For example, in the vibration motor 1, the second motor electrode portion 32 may alternatively be annular and be arranged to surround the circumference of the first motor electrode portion 31 with a radial gap between the first and second motor electrode portions 31 and 32. Also, the first and second motor electrode portions 31a and 32a as illustrated in FIG. 11 may alternatively be provided in the vibration motor 1, and the first and second motor electrode portions 31 and 32 as illustrated in FIG. 5 may alternatively be provided in the vibration motor 1a.

The lower sheet 41 may not necessarily include the sheet recessed portions 411 and 412. The lower sheet 41a may not necessarily include the sheet recessed portions 411a and 412a. Also, each of the lower sheets 41 and 41a may not necessarily include a portion arranged between the motor electrode portion 3 or 3a and the base portion 12, and may be arranged only around the motor electrode portion 3 or 3a.

In the vibration motor 1, the entire lower surface of the insulation sheet 42 may alternatively be covered with the lower sheet 41. Also, the vibration motor 1 may not include the insulation sheet 42. Meanwhile, in the vibration motor 1b, an insulation sheet may be arranged around each of the first and second motor electrode portions 31b and 32b between the second circuit board 132 and the lower sheet 41b. The vibration motors 1, 1a, and 1b may not include the lower sheets 41, 41a, and 41b, respectively.

Attachment and fixing of the members of each of the vibration motors 1, 1a, and 1b may be achieved in an indirect manner. For example, as long as each of the circuit boards 13 and 13b is arranged above the base portion 12, another member may be arranged to intervene between the circuit board 13 or 13b and the base portion 12. Also, the coil portion 14 may be attached to each of the circuit boards 13 and 13b with another member intervening therebetween. Each of the attachment of the shaft 15 to each of the cover portion 11 and the base portion 12, the attachment of the magnet portion 17 to the rotor holder 16, the attachment of the eccentric weight 18 to the rotor holder 16, the fixing of the cover portion 11 to the base portion 12, and so on may also be achieved with an intervention of another member. Each of the fixing of the insulation sheet 42 to the base portion 12, the fixing of the lower sheet 41 to the insulation sheet 42 or the base portion 12, the fixing of the electrode holder 43 to the base portion 12, and so on may also be achieved with an intervention of another member.

In the vibrator-attached board 5, the shape and arrangement of each of the first and second board electrode portions 54 and 55 of the target board 51 may be modified appropriately.

In the manufacture of the vibration motor 1, the first and second motor electrode portions 31 and 32 may alternatively be prepared independently of each other, and be separately attached to the base portion 12 without use of the initial electrode workpiece 30. Also in the manufacture of the vibration motor 1a, the first and second motor electrode portions 31a and 32a may alternatively be prepared independently of each other, and be separately attached to the base portion 12 without use of the initial electrode workpiece 30a.

Features of the above-described preferred embodiments and the modifications thereof may be combined appropriately as long as no conflict arises.

Vibration motors and vibrator-attached boards according to preferred embodiments of the present invention may be used for various purposes. Vibration motors and vibrator-attached boards according to preferred embodiments of the present invention are preferably used in, for example, silent notification devices in mobile communication apparatuses, such as cellular phones or the like.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a base portion arranged to extend perpendicularly to a central axis extending in a vertical direction;
a shaft having a lower end fixed to the base portion, and arranged to project upward along the central axis;
a circuit board arranged above the base portion;
a coil portion attached to the circuit board, and arranged radially opposite to the shaft with a gap therebetween;
a bearing portion attached to the shaft to be rotatable with respect to the shaft above the coil portion;
a rotor holder attached to the bearing portion;
a magnet portion attached to the rotor holder;
an eccentric weight attached to the rotor holder;
a cover portion arranged to cover, at least in part, upper and lateral sides of the rotor holder and the eccentric weight, and fixed to an upper end of the shaft and an outer edge portion of the base portion; and
a motor electrode portion electrically connected to the circuit board, and arranged to project downward below a lower surface of the base portion; wherein
the entire base portion and the entire circuit board are arranged inside of an outer circumferential edge of a lower end of the cover portion.

2. The vibration motor according to claim 1, wherein
the cover portion is cylindrical;
the outer circumferential edge of the lower end of the cover portion is circular; and
the base portion is in a shape of a disk.

3. The vibration motor according to claim 1, further comprising a lower sheet in a shape of a sheet, being elastically deformable, and attached to the lower surface of the base portion around the motor electrode portion.

4. The vibration motor according to claim 3, wherein the lower sheet includes a portion arranged between the motor electrode portion and the base portion.

5. The vibration motor according to claim 3, further comprising an insulation sheet arranged between the base portion and the lower sheet.

6. The vibration motor according to claim 5, wherein the insulation sheet is fixed to the base portion through an adhesive layer.

7. The vibration motor according to claim 5, wherein a portion of a lower surface of the insulation sheet is not covered with the lower sheet.

8. The vibration motor according to claim 1, wherein the motor electrode portion includes:
a first motor electrode portion; and
an arc-shaped second motor electrode portion arranged around the first motor electrode portion with a radial gap therebetween.

9. The vibration motor according to claim 3, wherein
the motor electrode portion includes:
a first motor electrode portion arranged on the central axis; and
an arc-shaped second motor electrode portion arranged around the first motor electrode portion with a radial gap therebetween; and
the lower sheet includes a portion arranged between the first motor electrode portion and the base portion, the portion defining a sheet recessed portion recessed upward relative to another portion of the lower sheet.

10. The vibration motor according to claim 3, wherein
the motor electrode portion includes:
a first motor electrode portion; and
an arc-shaped second motor electrode portion arranged around the first motor electrode portion with a radial gap therebetween; and
the second motor electrode portion is arranged on a lateral side of the lower sheet below the base portion, and is arranged radially opposite to the lower sheet.

11. The vibration motor according to claim 1, further comprising an electrode holder attached to the lower surface of the base portion, and arranged to have the motor electrode portion fixed to a lower surface thereof.

12. The vibration motor according to claim 3, further comprising an electrode holder arranged on a lateral side of the lower sheet below the base portion, attached to the lower surface of the base portion, and arranged to have the motor electrode portion fixed to a lower surface thereof.

13. The vibration motor according to claim 11, wherein the electrode holder includes a holder projecting portion arranged to project downward on a lateral side of the motor electrode portion.

14. The vibration motor according to claim 1, wherein the motor electrode portion includes:
a first motor electrode portion defined by a coil spring; and
a second motor electrode portion defined by a coil spring.

15. The vibration motor according to claim 14, wherein
the circuit board includes:
a first circuit board arranged on an upper surface of the base portion; and
a second circuit board electrically connected to the first circuit board, and arranged on the lower surface of the base portion; and
each of the first and second motor electrode portions is connected to the second circuit board.

16. The vibration motor according to claim 15, wherein the circuit board further includes a connection portion arranged to connect the first and second circuit boards to each other; and
the connection portion is arranged on a lateral side of the base portion.

17. A vibrator-attached board comprising:
the vibration motor of claim 1; and a target board having the vibration motor attached thereto, and including a board electrode portion arranged to make contact with the motor electrode portion of the vibration motor; wherein
the board electrode portion includes:
a first board electrode portion; and
an annular second board electrode portion arranged to surround a circumference of the first board electrode portion with a radial gap between the first and second board electrode portions.

18. A silent notification device comprising the vibration motor of claim 1.

19. A method for manufacturing a vibration motor including a base portion arranged to extend perpendicularly to a central axis extending in a vertical direction; a shaft having a lower end fixed to the base portion, and arranged to project upward along the central axis; a circuit board arranged above the base portion; a coil portion attached to the circuit board, and arranged radially opposite to the shaft with a gap therebetween;
a bearing portion attached to the shaft to be rotatable with respect to the shaft above the coil portion; a rotor holder attached to the bearing portion; a magnet portion attached to the rotor holder; an eccentric weight attached to the rotor holder; a cover portion arranged to cover, at least in part, upper and lateral sides of the rotor holder and the eccentric weight, and fixed to an upper end of the shaft and an outer edge portion of the base portion; and a first motor electrode portion and a second motor electrode portion each of which is electrically connected to the circuit board, the method comprising the steps of:
a) preparing an initial electrode workpiece including the first and second motor electrode portions and a support member arranged to support the first and second motor electrode portions;
b) attaching the initial electrode workpiece to the base portion such that each of the first and second motor electrode portions projects downward relative to a lower surface of the base portion, and electrically connecting each of the first and second motor electrode portions to the circuit board;
c) removing the support member; and
d) fixing the cover portion to the outer edge portion of the base portion such that the entire base portion and the entire circuit board are arranged inside of an outer circumferential edge of a lower end of the cover portion.

20. The method for manufacturing the vibration motor according to claim 19, the method further comprising the steps of:
e) before step b), fixing an insulation sheet to the lower surface of the base portion; and
f) before step b), fixing a lower sheet to a lower surface of the insulation sheet such that a portion of the lower surface of the insulation sheet is not covered with the lower sheet; wherein
in step b), the initial electrode workpiece is brought into contact with a lower surface of the lower sheet and the lower surface of the insulation sheet when the initial electrode workpiece is attached to the base portion.

21. The method for manufacturing the vibration motor according to claim 20, the method further comprising the step of g) fixing each of the first and second motor electrode portions of the initial electrode workpiece to an electrode holder between steps a) and b), wherein in step b), the electrode holder is attached to the lower surface of the base portion, so that the initial electrode workpiece is attached to the base portion.
